(19) United States
(12) Patent Application Publication
(10) Pub. No.: US 2025/0096965 A1
(43) Pub. Date: Mar. 20, 2025

(54) UE-OBJECT ASSOCIATION ASSIST MULTI-DEVICE AGGREGATION

(71) Applicant: QUALCOMM Incorporated, San Diego, CA (US)

(72) Inventors: Yucheng DAI, San Diego, CA (US); Wooseok NAM, San Diego, CA (US); Tao LUO, San Diego, CA (US)

(21) Appl. No.: 18/470,126

(22) Filed: Sep. 19, 2023

(51) Int. Cl. H04L 5/00; H04W 36/08; H04W 48/20

(52) U.S. Cl. CPC H04L 5/0037; H04L 5/006; H04W 36/08; H04W 48/20

(57) ABSTRACT

A method for wireless communication at a user equipment (UE) and related apparatus are provided. In the method, the UE receives a multi-device aggregation (MDA) indication from a network entity. The MDA indication indicates an inclusion of the first UE in an aggregation of multiple UEs associated with an object. The UE then performs, based on the aggregation of the multiple UEs, an MDA operation via a physical (PHY) or medium access control (MAC) layer shared among the multiple UEs. The MDA operation includes one or more of beam management, channel state information (CSI) measurement or reporting, radio resource management (RRM), cell selection or reselection, or a positioning operation.

### TECHNICAL FIELD

The present disclosure relates generally to communication systems, and more particularly, to multi-device aggregation with the assistance of user equipment (UE) and object association.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to receive, from a network entity, a multi-device aggregation (MDA) indication, where the MDA indication indicates the inclusion of the first UE in an aggregation of multiple UEs associated with an object; and perform, based on the aggregation of the multiple UEs, an MDA operation via a physical (PHY) or medium access control (MAC) layer shared among the multiple UEs.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to transmit an MDA indication to a first UE, where the MDA indication indicates the inclusion of the first UE in an aggregation of multiple UEs associated with an object; and communicate with the multiple UEs via a PHY/MAC layer shared among the multiple UEs based on the association of the multiple UEs with the object.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of location detection of a device-free object using RF sensing.

FIG. 5A is a diagram illustrating an example of various devices in a wireless personal network (WPN).

FIG. 5B is a diagram illustrating an example of various devices in a multi-device aggregation in accordance with various aspects of the present disclosure.

FIG. 6 is a diagram illustrating an example multi-device aggregation (MDA) procedure in accordance with various aspects of the present disclosure.

FIG. 7 is a diagram illustrating an example of executing procedures based on the UE-object association.

FIG. 8 is a call flow diagram illustrating a method of wireless communication in accordance with various aspects of the present disclosure.

FIG. 9 is a flowchart illustrating methods of wireless communication at a first UE in accordance with various aspects of the present disclosure.

FIG. 10 is a flowchart illustrating methods of wireless communication at a first UE in accordance with various aspects of the present disclosure.

FIG. 11 is a flowchart illustrating methods of wireless communication at a network entity in accordance with various aspects of the present disclosure.

FIG. 12 is a flowchart illustrating methods of wireless communication at a network entity in accordance with various aspects of the present disclosure.

FIG. 13 is a diagram illustrating an example of a hardware implementation for an example apparatus and/or network entity.

FIG. 14 is a diagram illustrating an example of a hardware implementation for an example network entity.

### DETAILED DESCRIPTION

In wireless communication, several devices, such as user equipment (UE) that are closely related (e.g., located near the same person) may connect with each other to facilitate data sharing and communication. For example, devices in a wireless personal network (WPN) may exchange data with each other via certain links. However, this data exchange is not limited to physical (PHY)/medium access control (MAC) layer, but also extends to higher layers. In some scenarios, confidential information, such as passwords and access credentials for a device, may be shared among devices in a WPN. This presents challenges related to efficiency, resource optimization, and user privacy. Example aspects present herein introduce methods and apparatus for multi-device aggregation that leverage the association between the UE and an associated object (e.g., carried by a same person, located on a same vehicle such as a bus, train, airplane, among other examples), in a way that improves efficiency and resource optimization while also providing enhanced data privacy.

Various aspects relate generally to wireless communication. Some aspects more specifically relate to multi-device aggregation with the assistance of UE and object association in wireless communication. In some examples, a UE may receive a multi-device aggregation (MDA) indication from a network entity. The MDA indication may indicate an inclusion of the first UE in an aggregation of multiple UEs associated with an object. The UE may further perform, based on the aggregation of the multiple UEs, an MDA operation via a PHY/MAC layer shared among the multiple UEs. In some aspects, the MDA operation may include one or more of: beam management based on the aggregation of the multiple UEs with the object, channel state information (CSI) measurement or reporting based on the aggregation of the multiple UEs with the object, radio resource management (RRM) based on the aggregation of the multiple UEs with the object, cell selection or reselection based on the aggregation of the multiple UEs with the object, or a positioning operation based on the aggregation of the multiple UEs with the object.

Particular aspects of the subject matter described in this disclosure can be implemented to realize one or more of the following potential advantages. In some aspects, by enabling multiple UEs associated with an object to share the PHY/MAC layer data without sharing higher-layer data, the described techniques reduce the signaling overheads and enhance efficiency in various applications, such as beam managements, CSI measurement and reporting, and positioning. In some aspects, by designating one UE as a primary UE to perform procedures for other UEs, the described techniques may effectively allocate the operational loads based on factors such as the battery status of the UEs. In some aspects, by providing varied CSI configurations to the UEs based on their association status, the described techniques ensure optimal beam management and power consumption. In some aspects, by allowing the primary UE to provide position information for other associated UEs, the described techniques reduce the need for other UEs to individually determine their positions, thereby improving the resource efficiency.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

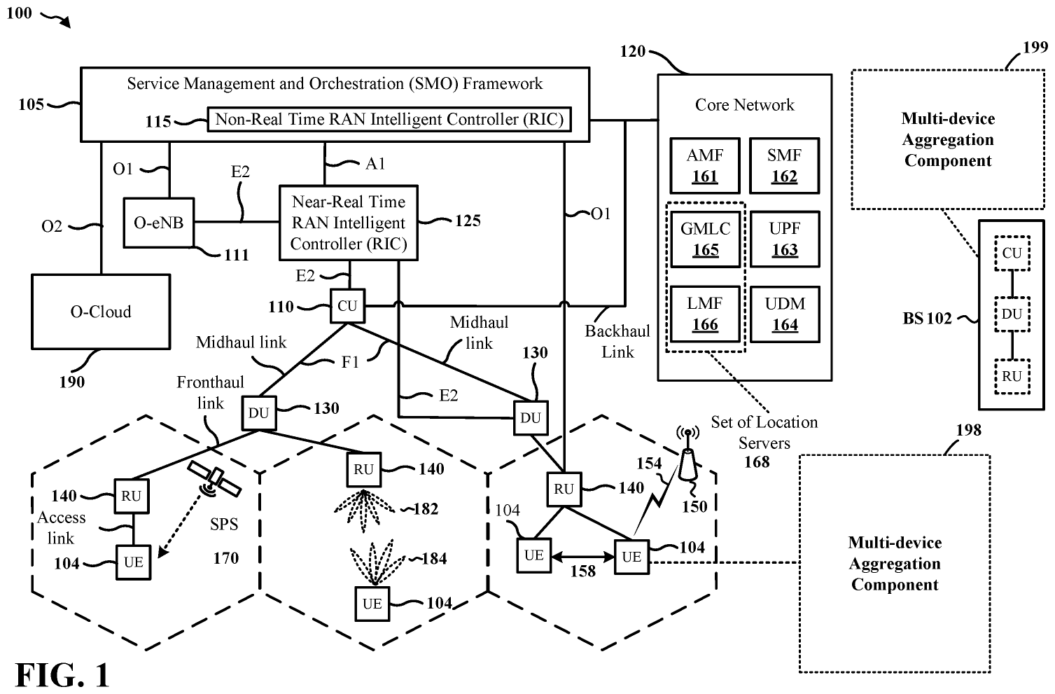

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE position information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smartphone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a multi-device aggregation component 198. The multi-device aggregation component 198 may be configured to receive, from a network entity, an MDA indication. The MDA indication may indicate an inclusion of the first UE in an aggregation of multiple UEs associated with an object. The multi-device aggregation component 198 may be further configured to perform, based on the aggregation of the multiple UEs, an MDA operation via a PHY/MAC layer shared among the multiple UEs. In certain aspects, the base station 102 may include a multi-device aggregation component 199. The multi-device aggregation component 199 may be configured to transmit an MDA indication to a first UE. The MDA indication may indicate an inclusion of the first UE in an aggregation of multiple UEs associated with an object. The multi-device aggregation component 199 may be further configured to communicate with the multiple UEs via a PHY/MAC layer shared among the multiple UEs based on the association of the multiple UEs with the object. Although the following description may be focused on 5G NR, the concepts described herein may be applicable to other similar areas, such as LTE, LTE-A, CDMA, GSM, and other wireless technologies.

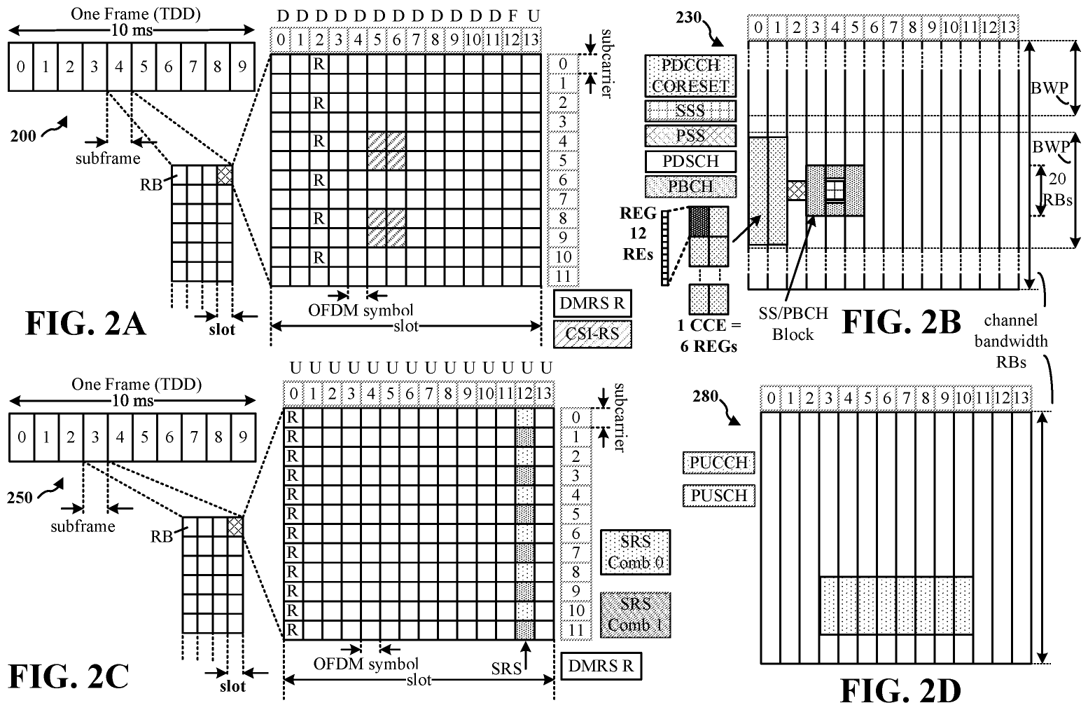

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ} * 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

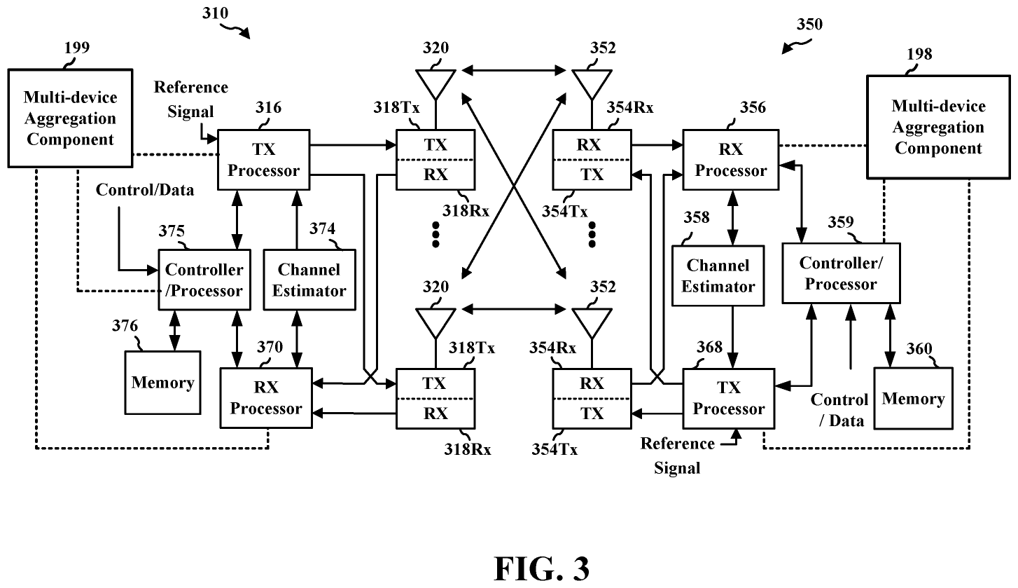

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the multi-device aggregation component 198 of FIG. 1.

At least one of the TX processor 316, the RX processor 370, and the controller/processor 375 may be configured to perform aspects in connection with the multi-device aggregation component 199 of FIG. 1.

Example aspects presented herein provide methods and apparatus of UE aggregation to enable efficient communications with the network if one UE can do the job on behalf of the others. This is beneficial from beam management and CSI-RS reporting perspective.

In wireless communication system, some communication devices may support radio frequency (RF) sensing. In some aspects, RF sensing may be provided as a consumer-level radar with advanced detection capabilities. This technology may enable touchless and device-free communication with various devices or systems. In some examples, RF sensing may repurpose the RF waveforms used for wireless communication. As one non-limiting example, RF sensing may utilize the waveforms from 3GPP NR, such as the millimeter wave (mmWave) RF signals. In some aspects, the RF signals may be in a frequency range such as FR2, FR2x, or FR4 for accurate range or distance detection.

Possible use cases of RF sensing may include applications in, for example, health monitoring, gesture recognition, contextual information acquisition, and automotive radar. For example, in health monitoring. RF sensing may be used for heartbeat detection and respiration rate monitoring. In gesture recognition, RF sensing may be used for human activity recognition, keystroke detection, and sign language recognition. Furthermore, RF sensing may gather contextual information about its environment and provide location detection and tracking, direction determination, and range estimation. RF sensing may also be used in automotive technology, such as smart cruise control and collision avoidance.

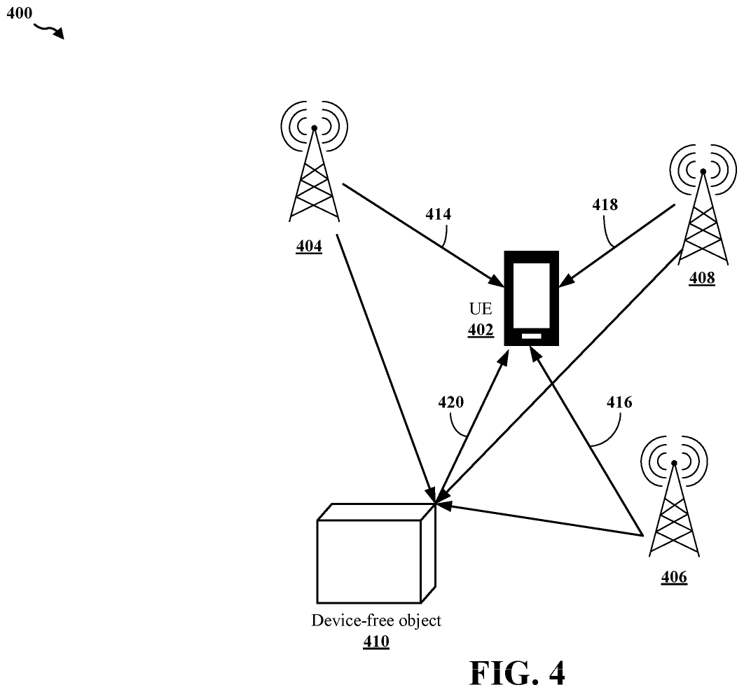

FIG. 4 is a diagram 400 illustrating an example of location detection of a device-free object (e.g., an object without wireless communication capability) using RF sensing. In FIG. 4, a UE 402 may perform location detection on a device-free object 410 based on the signals the UE 402 received from one or more base stations (e.g., signal 414 received from base station 404, signal 416 received from base station 406, and signal 418 received from base station 408) and the reflection signal (e.g., a reflection of the signals 414, 416, and/or 418) that reflects from the object 410 (which may be referred to as a device-free object) (e.g., reflected signal 420).

In some examples, a mobile UE may be carried by, located on, or otherwise associated with an object. In some aspects, the object may be a person. For example, a person may carry various UE devices, such as smartphones, smartwatches, head-mounted displays (HMDs), and/or notebook computers. Similarly, one or more devices may be carried in or located on a vehicle. Among other examples, vehicles such as cars, drones, airplanes, trains, buses, and automated guided vehicles (AGVs) may carry UE devices and/or passengers having UE devices. As one example, vehicles may include infotainment systems and electronic control units (ECUs).

In these examples, detecting and monitoring the association relationship (e.g., the UE-object association) between the UE and its associated object may be beneficial for various applications. For example, when a UE is associated with an object, the object may act as a proxy of the UE or vice versa for tracking and managing the UE. Depending on various factors, the association relationship between a UE and its object may be permanent or may be temporary. In some examples, the objects associated with the UEs may be detectable through different perception schemes. For example, the object may retain detectable characteristics, such as a large radar cross section (RCS), a unique micro-Doppler profile, or a distinct temperature profile. On the other hand, the UE may be a generic device with specialized capabilities. For example, a UE may possess positioning (e.g., among other examples NR positioning) or sensing capabilities, or both.

The UE-object associations may facilitate various applications in wireless communication. Applications benefiting from the UE-object association may include, for example, sensing-assisted beam management, the detection and mitigation of maximum permissible exposure (MPE) issues, multi-device aggregation, public security, device anti-theft or loss, and health monitoring, such as vital signal monitoring and fall detection.

In some examples, one object might be associated with multiple devices (e.g., UEs), and the multiple devices (e.g., UEs) may collectively form a multi-device aggregation associated with the object. Example scenarios where the multi-device aggregation could occur may include a person simultaneously carrying a smartphone, a smartwatch, and smart glasses, or multiple persons, each with their own smartphones, traveling together in a common vehicle, such as a bus or a train. The devices in a multi-device aggregation might not be connected to each other, for example, through Bluetooth™ or sidelink (SL). Compared to a WPN, where devices may share data in the physical (PHY) or MAC layer or a higher layer, the devices in a multi-device aggregation might not necessarily exchange data but may simply share system overhead, which can provide system efficiencies while maintaining privacy for individual UEs. Additionally, devices (e.g., UEs) associated with the same object may exhibit similar physical characteristics, including similar positions, movement patterns, beams, and link qualities.

For the devices (e.g., UEs) in the multi-device aggregation based on the devices' association with an object (e.g., the UE-object association), various procedures or applications, such as the positioning and beam management (BM) processes, may be conducted individually by UEs even if they are associated with the same object. By leveraging the object association, some metrics, such as the position, may be obtained by sensing the object. However, without the aggregation mechanism, these associated UEs may be processed separately, which may result in higher consumption of time and spectral resources.

Hence, once the association between one object and its multiple UEs is identified. these UEs may be aggregated to share PHY and MAC procedures. Such an approach is not only energy-efficient but also reduces system overhead. This aggregation may improve processes such as beam management, CSI measurement and reporting, radio resource management (RRM), cell reselection, and positioning. Additionally, within the aggregated devices (e.g., UEs), one device (e.g., UE) may be designated as the primary device (e.g., UE), and perform one or more procedures for (e.g., on behalf of or as a representative of) the rest of the devices (e.g., UEs), thereby enhancing the efficiency.

Example aspects presented herein relate to methods and apparatuses for wireless communication applications that leverage multi-device aggregation (MDA), offering an alternative approach to the traditional wireless personal network (WPN). WPN is includes data sharing within its network. Devices in a WPN may be connected to each other via certain links, such as Bluetooth™ or SL. Data exchange within these devices may not be limited to the PHY/MAC layer but also extend to higher-layer data. Devices in a personal network may be considered to be associated with the same person and may share confidential information, such as passwords and access credentials. In a WPN, a proxy UE may function as the intermediary between the network and other devices. In contrast, example aspects presented herein propose MDA based on UE-object association. Unlike a WPN, UEs in the MDA might not be connected via local links like Bluetooth™ or SL. In some examples, UEs in the MDA may not even be aware of the presence of other UEs associated with the same object. The network (e.g., a base station) may indicate to the UEs to enter the MDA mode and adjust various applications or procedures, such as beam management (BM) or positioning procedures based on the MDA. In the MDA based on the UE-object association, the data sharing among the UEs may be limited to PHY/MAC layer information, e.g., without other data sharing (e.g., without high-layer data sharing) between the UEs. The UEs in the MDA may or may not belong to the same person. For instance, the UEs in the MDA may include the smartphones of different passengers in a car. Avoiding high-layer data sharing may address privacy concerns. Additionally, data sharing among the UEs in the MDA may be realized and controlled via the network (e.g., via a base station). For example, a primary UE among the multiple UEs in the MDA may report its position to the network, and the network may then share this information with other MDA UEs.

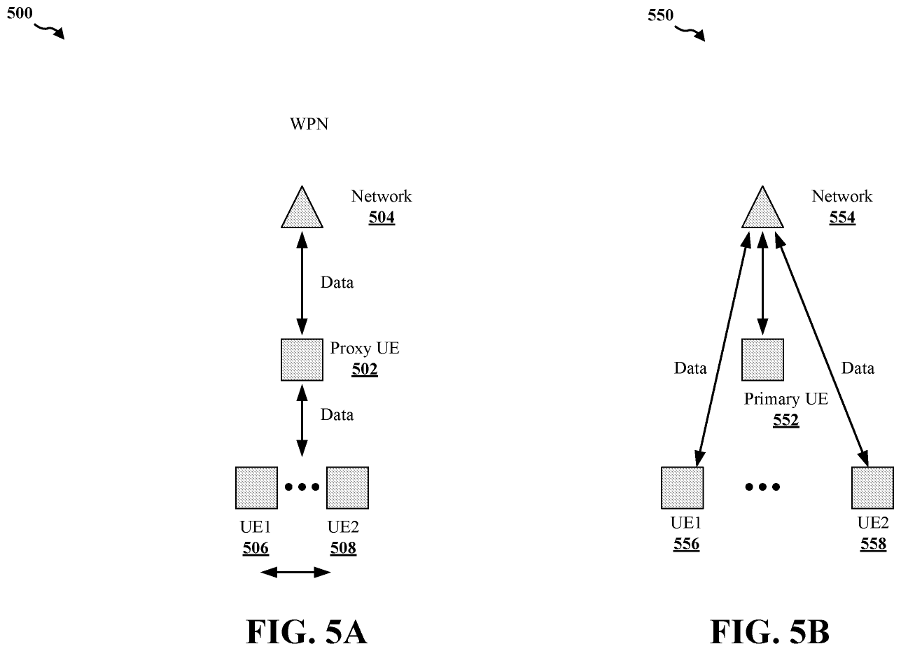

FIG. 5A is a diagram 500 illustrating an example of various devices in a WPN. In FIG. 5A, multiple UEs (e.g., UE1 506, UE2 508) may be connected with each other (e.g., through Bluetooth™ or SL). A proxy UE 502 may serve as the intermediary between the network 504 and other UEs (e.g., UE1 506, UE2 508). The UEs (e.g., UE1 506, UE2 508) in the WPN may be considered associated with the same person may share data, including confidential information, with each other.

FIG. 5B is a diagram 550 illustrating an example of various devices in a multi-device aggregation in accordance with various aspects of the present disclosure. In FIG. 5B, the multi-device aggregation may include multiple UEs (e.g., UE1 556 and UE2 558), which may not be connected via local links. The network 554 may indicate the multiple UEs (e.g., UE1 556 and UE2 558) to enter an MDA mode and adjust related procedures (e.g., beam management or positioning procedures) based on multi-device aggregation. The multiple UEs e.g., (UE1 556 and UE2 558) may share PHY/MAC layer information but may not share other data (e.g., higher-layer data). One primary UE 552 may be designated among the multiple UEs, and the primary UE 552 perform the procedures (e.g., beam management or positioning procedures) for the rest of the UEs (e.g., UE1 556 and UE2 558). For example, the primary UE 552 may transmit beam management reports/transmissions and/or positioning information/transmissions, which may be skipped by the other UEs. The network 554 may use the measurement information or transmissions from the primary UE 552 to make beam management or positioning determinations for the group of UEs.

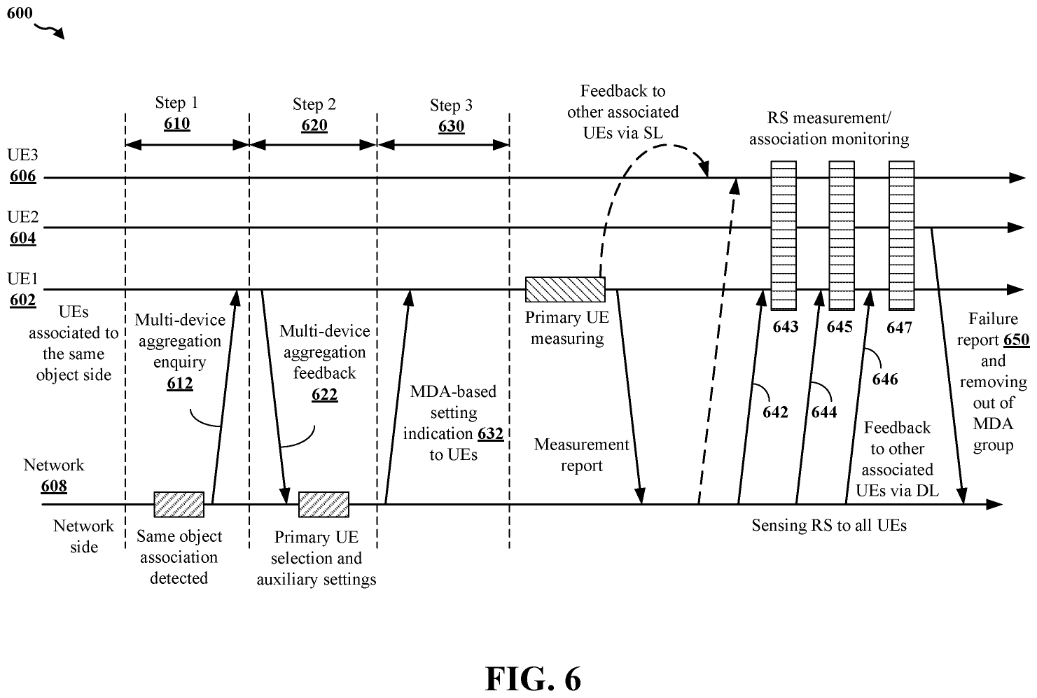

In some aspects, the MDA procedure may involve several steps. FIG. 6 is a diagram 600 illustrating an example MDA procedure in accordance with various aspects of the present disclosure. In FIG. 6, in the first step (step 1 610), a network 608 (e.g., a base station) may send out an enquiry 612 to the UEs (e.g., UE1 602) associated with an object. Through this enquiry 612, the network 608 may collect various information about the UEs. This information may include basic UE information, such as device ID and positional data of the UE, the sidelink (SL) capability of the UE, the battery status, the hardware type (e.g., a smartphone or wearable device), and the UE's capabilities. The UEs (e.g., UE1 602, UE2 604, and UE3 606) associated with a same object may form an MDA group associated with that object.

Following the enquiry to the UEs, in the second step (e.g., step 2 620), the network 608 may collect the feedback 622 from the UEs (e.g., UE1 602) and designate one UE (e.g., UE1 602) as the primary UE among the multiple UEs (e.g., UE1 602, UE2 604, and UE3 606). Additionally, the network 608 may identify a link quality threshold and collect extra information for specific applications to the UEs (e.g., UE1 602, UE2 604, and UE3 606).

Then, the network 608 may communicate the indication about the decision (e.g., the primary UE designation) and other settings to the UEs in the MDA group (e.g., via the MDA-based setting indication 632 in step 3 630). This communication may take the form of broadcasts and unicasts via downlink (DL). The UEs in the MDA group may keep monitoring a sensing reference signal (RS) and possibly report other relevant metrics to ensure the validity of the object association (e.g., to ensure the inclusion of the UE in the MDA group is valid). For example, as shown in FIG. 6, the network 608 may transmit a sensing RS to the UEs in the MDA group (e.g., at 642, 644, 646), and the UEs may perform RS measurement on the sensing RS (e.g., at 643, 645, 647, respectively).

In some aspects, the inclusion of the UE in the MDA may become invalid (e.g., due to the UE moving farther away from the object). In that case, failures in maintaining the association may trigger a subsequent procedure, which may involve removing the specific UE that encountered the association failure from the MDA group. For example, as shown in FIG. 6, assuming one UE in the MDA group (e.g., UE2 604) no longer have a valid association with the object based on the measurement on the sensing RS, the UE (e.g., UE2 604) may transmit a failure report 650 to the network 608 to indicate the invalid association, and the UE (e.g., UE2 604) or the network 608, or both may perform a procedure to remove the UE (e.g., UE2 604) from the MDA group.

In some aspects, certain procedures, such as the beam management (BM) and channel state information (CSI) measurement/reporting processes, may be improved by leveraging the MDA based on the UE-object association.

In some examples, the network may indicate the UEs in an MDA and/or the UEs that could potentially be associated with the MDA, collectively referred to as “MDA candidate UE,” two sets of configurations, an MDA configuration and a fallback configuration, for beam management and CSI measurement/reporting processes. When a UE becomes associated or re-associated with the MDA group, the UE may automatically apply the MDA configuration. On the other hand, once a UE is removed from the MDA group, it will automatically apply the fallback configuration, which may not involve the MDA.

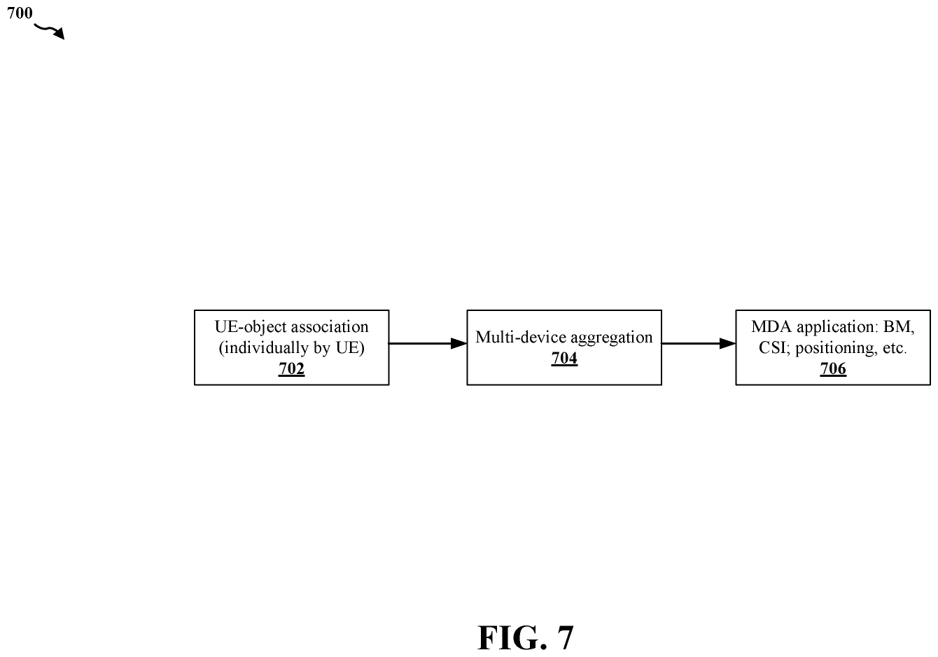

FIG. 7 is a diagram 700 illustrating an example of executing procedures based on the UE-object association. As shown in FIG. 7, when a UE has a UE-objection association at 702, the UE and other UEs that associated with the same object may form a multi-device aggregation at 704. Based on the multi-device aggregation, the UE may perform various MDA applications (at 706), such as beam management, CSI measurement and report, or positioning applications, based on the multi-device aggregation.

In some aspects, the MDA configurations may be implemented in various ways. In some examples, one designated primary UE of an MDA group may report CSI (and/or SRS transmission), while other UEs in the MDA group may measure the CSI RS (and/or the sensing RS) and report a beam or association failure. The primary UE may report the CSI regularly (without additional configurations) or use a larger CSI report periodicity for reporting CSI, or further enter an association-based beam management mode. In these scenarios, the power consumption may mainly occur on the primary UE, and the CSI report periodicity for other UEs in the MDA group may be reconfigured.

In some examples, the network may configure different UEs with varied CSI report offsets and longer CSI report periodicity (compared to the regular CSI report periodicity for an individual UE not associated with an MDA). For example, if there are X UEs associated with an object, the network may configure a new CSI report periodicity that is X times the length of a regular CSI report periodicity. In these scenarios, the network may receive the CSI reports more frequently compared to the scenarios where the primary UE is tasked with CSI reporting. These CSI reports may reflect information about the channels of different UEs (while the CSI report provided by the primary UE is related to the channel associated with the primary UE), which may be used for validating the UE-object association for the UEs in the MDA group. Additionally, the power consumption may be evenly distributed across different UEs, as all of the UE are reporting CSI.

In some examples, when a UE's association with an object becomes invalid, the UE may use the fallback configuration for beam management (e.g., the UE may use a conventional beam management without involving any MDA group). In some examples, similar to the report in the case of beam failure or loss of association in the beam management based on UE-object association, the associated UEs (except the primary UE) may monitor the link quality by measuring the reference signal (RS), and determine whether the predicted Tx beam based on CSI measurement from the primary UE causes a beam failure. The determination of beam failure may be based on a defined link quality metric threshold, such as a threshold for reference signal received power (RSRP) value or a relative RSRP backoff (a reduction of RSRP at the UE). In some aspects, the link quality metric threshold may be defined, such as in a wireless standard or may be otherwise known in advance by the UE. In some aspects, the link quality metric threshold may either be selected at the UE side or, in some examples, indicated by the TRP via a message (e.g., configured for the UE by the network). For example, if the monitored link quality is below this threshold, the UE may indicate this to the TRP through various channels such as UCI, SRS, random access channel (RACH), or MAC-CE. In some examples, this feedback from the UE may include a request to trigger the fallback beam management (i.e., beam management under the fallback configuration) and a request to reconstruct the UE-object association. The feedback mechanism for the UE associated with an MDA is different from the failure report of beam management based on simple object association. For the UE associated with an MDA group, the feedback may also trigger the removal of the reporting UE from the MDA group. After the removal of the reporting UE from the MDA group, the reporting UE and the network may adopt the fallback configuration for beam management.

In some aspects, the positioning procedures may be optimized by leveraging the MDA based on the UE-object association. In some examples, the MDA may enhance sensing-assisted positioning. As the UEs in an MDA are associated with an object, the position of the proxy object may be used as a representative for the positions of all devices within the MDA group. For example, once a UE-object association has been constructed and multiple UEs are associated with the same object, the network may indicate to the UEs in the MDA group to enter into a positioning mode based on the multi-device aggregation. The indication may include aspects like information of the primary UE (e.g., SL information and measurement periodicity), positioning request information (e.g., format, link and message for sending the request), and proxy position accuracy. The proxy position accuracy may be useful for applications that have high positioning accuracy, such as MPE, which may not be meet by using the position of one UE to represent that of another UE.

In MDA-based positioning, in some examples, the network may select a primary UE for the task of positioning. For other associated UEs to obtain the position information, they may place a positioning request, either through SL or UL, based on the indication from the network. When such a request is placed, the primary UE may conduct the positioning and subsequently providing feedback via either the SL or UL, based on the indication from the network. In one example, a UE may transmit a positioning request through UL to the network, and the network may transmit the positioning request to the primary UE for the primary UE to perform positioning operation to obtain position information for the UE. The position information may be delivered to the requesting UE through the SL or through the network. In some examples, if the position information is delivered by the TRP/network, the network may combine the estimated position from the UE with the object's position obtained from NR sensing to enhance the accuracy of position estimation.

In some examples, the primary UE may be fixed. In some examples, the primary UE may be designated dynamically (e.g., based on parameters such as the battery status of a UE). In some examples, if the derived position accuracy does not meet the requirements, other associated UEs may indicate the network to directly conduct NR positioning.

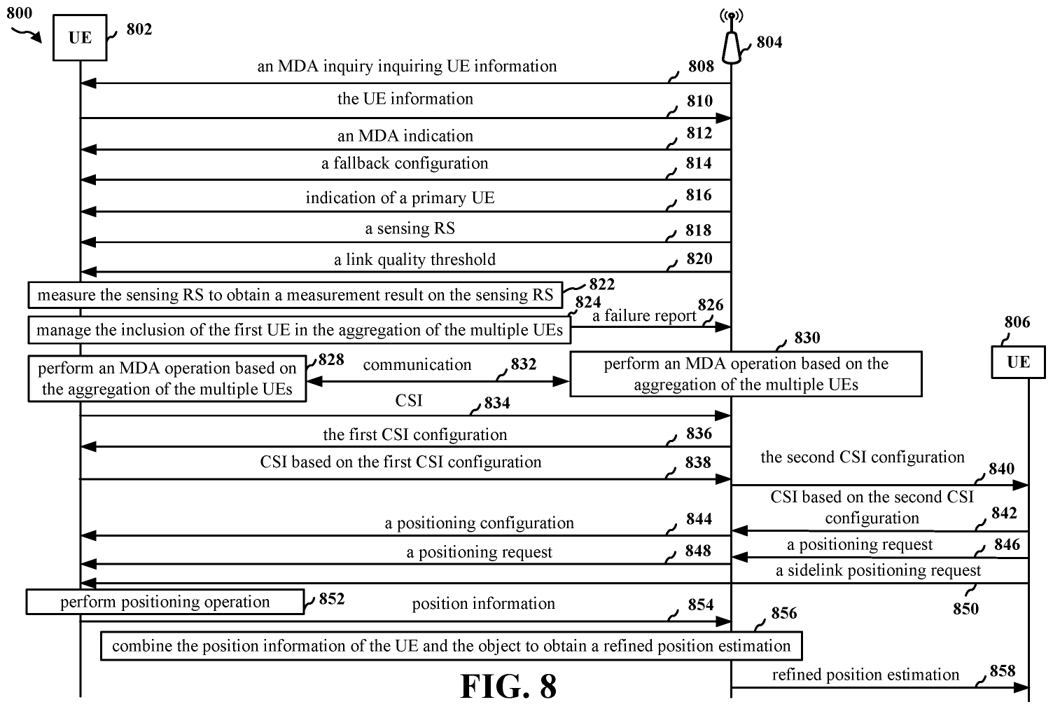

FIG. 8 is a call flow diagram 800 illustrating a method of wireless communication in accordance with various aspects of this present disclosure. Various aspects are described in connection with a first UE 802, a second UE 806, and a base station 804. The aspects may be performed by the first UE 802, the second UE 806, or the base station 804 in aggregation and/or by one or more components of a base station 804 (e.g., such as a CU 110, a DU 130, and/or an RU 140).

As shown in FIG. 8, at 808, the first UE 802 may receive an MDA inquiry inquiring UE information of the first UE 802 from the base station 804. For example, referring to FIG. 6, the UE (e.g., UE1 602) may receive a multi-device aggregation enquiry 612.

At 810, in response to the MDA inquiry (at 808), the first UE 802 may transmit the UE information of the first UE 802 to base station 804. In some examples, the UE information of the first UE 802 may include one or more of: the device identifier (ID) of the first UE 802, the position information of the first UE 802, the sidelink (SL) capability of the first UE 802, the battery status of the first UE 802, or the hardware type of the first UE 802 (e.g., whether the first UE 802 is a smartphone, a wearable device, etc.). For example, referring to FIG. 6, the network 608 may receive multi-device aggregation feedback 622 from UE1 602.

At 812, the first UE 802 may receive an MDA indication from base station 804. The MDA indication may indicate an inclusion of the first UE 802 to an aggregation of multiple UEs associated with an object. For example, referring to FIG. 6, the UE (e.g., UE1 602) may receive MDA-based setting indication 632 from the network 608.

At 814, the first UE 802 may receive a fallback configuration from the base station 804. The fallback configuration may not involve the aggregation of multiple UEs.

In some examples, at 816, the first UE 802 may receive an indication of a primary UE from base station 804. The indication may designate the first UE 802 as the primary UE of the aggregation of multiple UEs associated with the object. In some examples, the indication of a primary UE may be included in the MDA indication (at 812).

At 818, the base station 804 may transmit a sensing RS to the first UE 802 for the first UE 802 to measure the sensing RS. For example, referring to FIG. 6, the network 608 may transmit the sensing RS to the UE (e.g., UE1 602) at 642, 644, and 646.

At 820, the base station 804 may further transmit a link quality threshold to the first UE 802.

At 822, the first UE 802 may measure the sensing RS received from the base station 804 (at 818) to obtain a measurement result. In some examples, the measurement result may be based on the reference signal received power (RSRP) of the sensing RS at the first UE 802. In some examples, the measurement result may be based on the relative RSRP back off of the sensing RS at the first UE 802. In some examples, the measurement result may indicate whether the association of the first UE 802 with the object is valid. For example, referring to FIG. 6, the UE (e.g., UE1 602, UE2 604, and UE3 606) may perform measurement on the sensing RS at 643, 645, and 647.

In some example, the first UE 802 may, at 824, manage the inclusion of the first UE 802 in the aggregation of the multiple UEs based on the measurement result (at 822).

In some examples, if the measurement result (at 822) indicates a failed association between the first UE 802 and the object (e.g., when the measurement result does not meet the link quality threshold), the first UE 802 may, at 826, transmit a failure report to the base station 804. The failure report may indicate an invalidity of the inclusion of the first UE in the aggregation of the multiple UEs. For example, referring to FIG. 6, if the measurement result (e.g., at 647) indicates a failed association between the UE (e.g., UE2 604) and the object, the UE (e.g., UE2 604) may transmit a failure report 650 to the network 608.

At 828, the first UE 802 may perform, based on the aggregation of the multiple UEs, an MDA operation via a PHY/MAC layer shared among the multiple UEs. In some examples, the MDA operation may include one or more of beam management based on the aggregation of the multiple UEs with the object, CSI measurement or reporting based on the aggregation of the multiple UEs with the object, RRM based on the aggregation of the multiple UEs with the object, cell selection or reselection based on the aggregation of the multiple UEs with the object, or the positioning operation based on the aggregation of the multiple UEs with the object.

At 830, the base station 804 may perform, based on the aggregation of the multiple UEs, an MDA operation via a PHY/MAC layer shared among the multiple UEs. In some examples, the MDA operation may include one or more of beam management based on the aggregation of the multiple UEs with the object, CSI measurement or reporting based on the aggregation of the multiple UEs with the object, RRM based on the aggregation of the multiple UEs with the object, cell selection or reselection based on the aggregation of the multiple UEs with the object, or the positioning operation based on the aggregation of the multiple UEs with the object.

At 832, the base station 804 may communicate with multiple UEs (e.g., the first UE 802) via the PHY/MAC layer shared among the multiple UEs based on the association of the multiple UEs with the object.

In some examples, at 834, the first UE 802 may transmit CSI for the channel between the first UE 802 and the base station 804 to the base station 804. For example, when the first UE 802 is the primary UE of the multiple UEs, the first UE 802 may transmit the CSI (at 834) to the base station 804, and the CSI transmission (at 834) may not need additional configuration from the base station 804.

In some examples, at 836, the base station 804 may transmit the first CSI configuration to the first UE 802. The first CSI configuration may include the first report offset and the first report periodicity for reporting CSI.

In some examples, at 838, in response to the first CSI configuration (at 836), the first UE 802 may report (e.g., transmit) the CSI to the base station 804 based on the first report offset and the first report periodicity.

In some examples, at 840, the base station 804 may transmit to the second UE 806. The second CSI configuration may include the second report offset and the second report periodicity for reporting CSI. The second UE 806 may be one UE of the multiple UEs in the multi-device aggregation. That is, the first UE 802 and the second UE 806 may be associated with the same object and belong to the same MDA group.

In some examples, at 842, in response to the second CSI configuration (at 840), the second UE 806 may report (e.g., transmit) the CSI for the channel between the second UE 806 and the base station 804 to the base station 804 based on the second report offset and the second report periodicity.

In some examples, at 844, the base station 804 may transmit a positioning configuration to the first UE 802. The positioning configuration may indicate an MDA positioning mode. In some examples, the positioning configuration may include one or more of: sidelink information, a measuring periodicity, positioning request information for a positioning operation, or a positioning accuracy for the positioning operation.

In some examples, at 846, the base station 804 may receive, from the second UE 806, a positioning request. The base station 804 may transmit, at 848, the positioning request to the first UE 802 to indicate the first UE 802 to perform a positioning operation to obtain position information of the first UE.

In some examples, at 850, the second UE 806 may send a sidelink positioning request to the first UE 802.

At 852, the first UE 802 may perform positioning operation to obtain the position information of the first UE 802. In some examples, the first UE 802 may perform positioning operation in response to the positioning configuration received at 844. In some examples, the first UE 802 may perform positioning operation in response to the positioning request received at 848. In some examples, the first UE 802 may perform positioning operation in response to the sidelink positioning request received at 850. In some examples, the position information may be based on object position information for the object.

At 854, the base station 804 may receive the position information from the first UE 802.

In some examples, at 856, the base station 804 may combine the position information of the first UE 802 (received at 854) with the position information of the object to obtain a refined position estimation.

In some examples, at 858, the base station 804 may transmit the refined position estimation to the second UE 806.

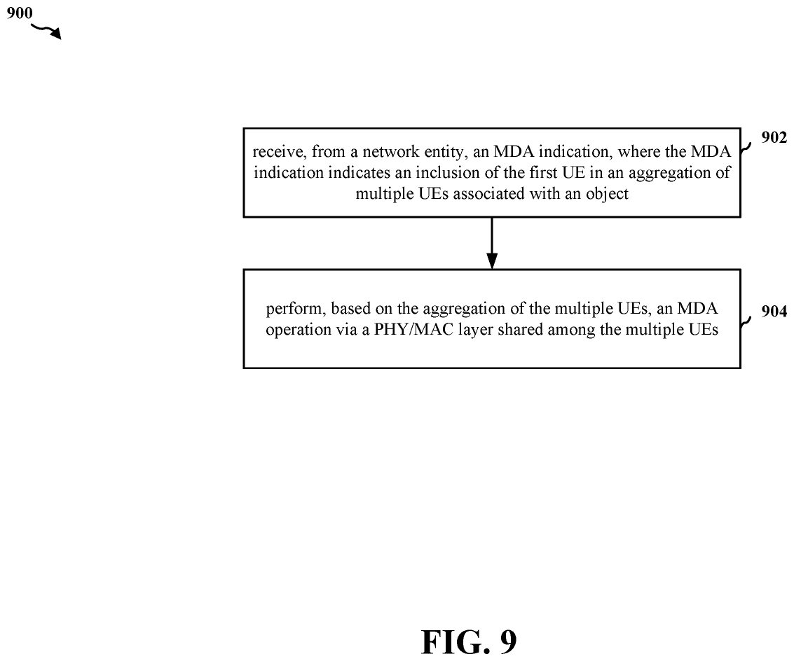

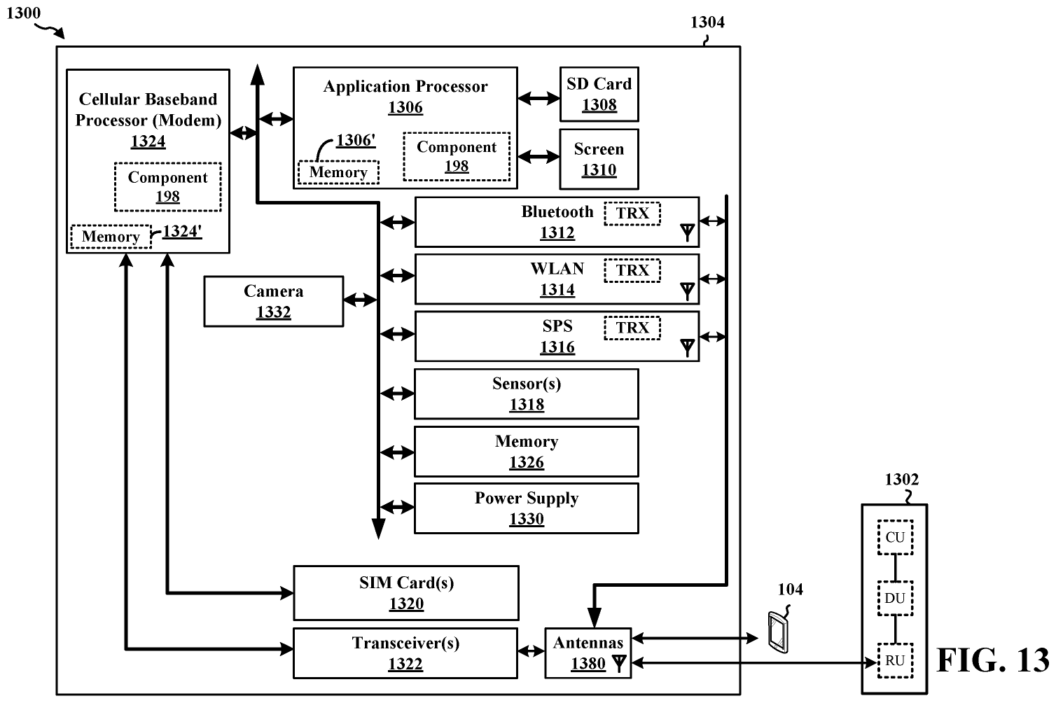

FIG. 9 is a flowchart 900 illustrating methods of wireless communication at a first UE in accordance with various aspects of the present disclosure. The method may be performed by the first UE. The first UE may be the UE 104, 350, 802, or the apparatus 1304 in the hardware implementation of FIG. 13. The methods allow multiple UEs associated with an object to share the PHY/MAC layer data without necessarily sharing higher-layer data. By leveraging the association of multiple devices with the object, the methods optimize the signaling overheads and enhance efficiency in various applications, such as beam managements, CSI reporting, and positioning applications.

As shown in FIG. 9, at 902, the first UE may receive an MDA indication from a network entity. The MDA indication may indicate an inclusion of the first UE in an aggregation of multiple UEs associated with an object. The network entity may be a base station, or a component of a base station, in the access network of FIG. 1 or a core network component (e.g., base station 102, 310, 804; or the network entity 1302 in the hardware implementation of FIG. 13). FIG. 6 and FIG. 8 illustrate various aspects of the steps in connection with flowchart 900. For example, referring to FIG. 8, the first UE 802 may, at 812, receive an MDA indication from a network entity (base station 804). Referring to FIG. 6, the UE (e.g., UE1 602) may receive MDA-based setting indication 632 from the network 608. The MDA indication may indicate an inclusion of the first UE 802 to an aggregation of multiple UEs associated with an object. In some aspects, 902 may be performed by the multi-device aggregation component 198.

At 904, the first UE may perform, based on the aggregation of the multiple UEs, an MDA operation. The MDA operation may be performed via a PHY/MAC layer shared among the multiple UEs. For example, referring to FIG. 8, the first UE 802 may perform, at 828, an MDA operation based on the aggregation of the multiple UEs. The MDA operation may be performed via a PHY/MAC layer shared among the multiple UEs. In some aspects, 904 may be performed by the multi-device aggregation component 198.

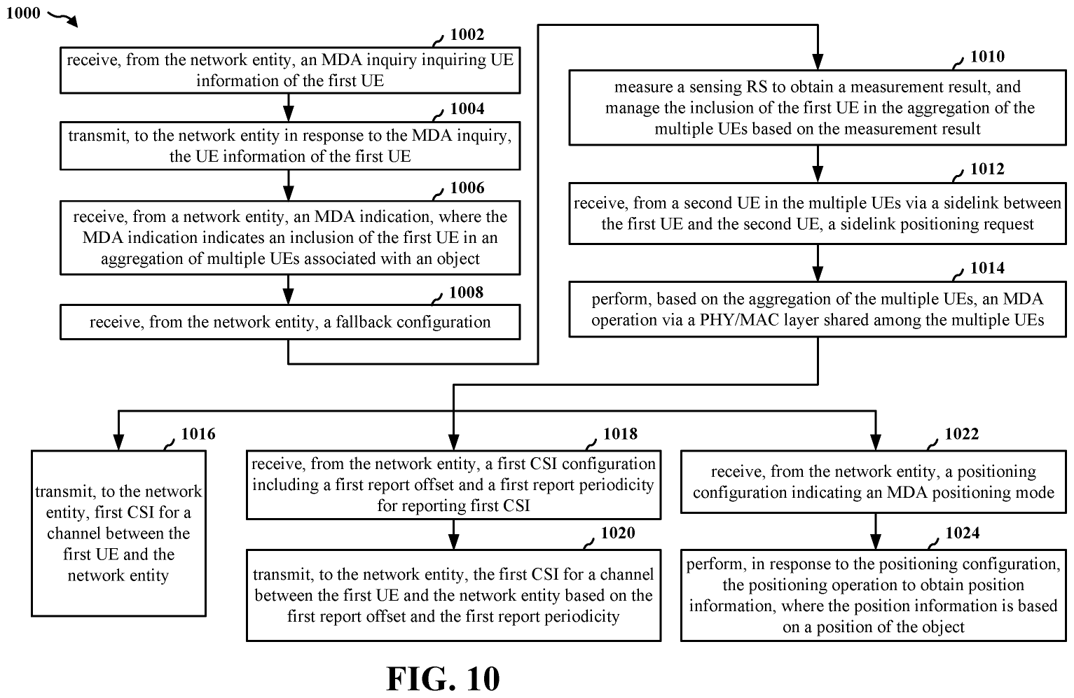

FIG. 10 is a flowchart 1000 illustrating methods of wireless communication at a first UE in accordance with various aspects of the present disclosure. The method may be performed by the first UE. The first UE may be the UE 104, 350, 802, or the apparatus 1304 in the hardware implementation of FIG. 13. The methods allow multiple UEs associated with an object to share the PHY/MAC layer data without necessarily sharing higher-layer data. By leveraging the association of multiple devices with the object, the methods optimize the signaling overheads and enhance efficiency in various applications, such as beam managements, CSI reporting, and positioning applications.

As shown in FIG. 10, at 1006, the first UE may receive an MDA indication from a network entity. The MDA indication may indicate an inclusion of the first UE in an aggregation of multiple UEs associated with an object. The network entity may be a base station, or a component of a base station, in the access network of FIG. 1 or a core network component (e.g., base station 102, 310, 804; or the network entity 1302 in the hardware implementation of FIG. 13). FIG. 6 and FIG. 8 illustrate various aspects of the steps in connection with flowchart 1000. For example, referring to FIG. 8, the first UE 802 may, at 812, receive an MDA indication from a network entity (base station 804). Referring to FIG. 6, the UE (e.g., UE1 602) may receive MDA-based setting indication 632 from the network 608. The MDA indication may indicate an inclusion of the first UE 802 to an aggregation of multiple UEs associated with an object. In some aspects, 1006 may be performed by the multi-device aggregation component 198.

At 1014, the first UE may perform, based on the aggregation of the multiple UEs, an MDA operation. The MDA operation may be performed via a PHY/MAC layer shared among the multiple UEs. For example, referring to FIG. 8, referring to FIG. 8, the first UE 802 may perform, at 828, an MDA operation based on the aggregation of the multiple UEs. The MDA operation may be performed via a PHY/MAC layer shared among the multiple UEs. In some aspects, 1014 may be performed by the multi-device aggregation component 198.

In some aspects, the MDA operation may include one or more of: beam management based on the aggregation of the multiple UEs with the object, CSI measurement or reporting based on the aggregation of the multiple UEs with the object, RRM based on the aggregation of the multiple UEs with the object, cell selection or reselection based on the aggregation of the multiple UEs with the object, or the positioning operation based on the aggregation of the multiple UEs with the object. For example, referring to FIG. 8, the MDA operation (at 828) may include one or more of: beam management based on the aggregation of the multiple UEs with the object, CSI measurement or reporting based on the aggregation of the multiple UEs with the object, RRM based on the aggregation of the multiple UEs with the object, cell selection or reselection based on the aggregation of the multiple UEs with the object, or the positioning operation based on the aggregation of the multiple UEs with the object.

In some aspects, at 1002, the first UE receive, from the network entity, an MDA inquiry inquiring UE information of the first UE. The first UE may further transmit, at 1004, to the network entity in response to the MDA inquiry, the UE information of the first UE. In some examples, the UE information of the first UE may include one or more of: the device ID of the first UE, position information of the first UE, the SL capability of the first UE, the battery status of the first UE, or the hardware type of the first UE. For example, referring to FIG. 8, the first UE 802 may receive, at 808, from the network entity (base station 804), an MDA inquiry inquiring UE information of the first UE 802. The first UE 802 may further transmit, at 810, to the network entity (base station 804) in response to the MDA inquiry, the UE information of the first UE 802. Referring to FIG. 6, the UE (e.g., UE1 602) may receive a multi-device aggregation enquiry 612, and the network 608 may receive multi-device aggregation feedback 622 from UE1 602. In some aspects, 1002 and 1004 may be performed by the multi-device aggregation component 198.

In some aspects, at 1010, the first UE may measure a sensing RS to obtain a measurement result, and manage the inclusion of the first UE in the aggregation of the multiple UEs based on the measurement result. For example, referring to FIG. 8, the first UE 802 may measure, at 822, a sensing RS to obtain a measurement result, and, at 824, manage the inclusion of the first UE 802 in the aggregation of the multiple UEs based on the measurement result. Referring to FIG. 6, the UE (e.g., UE1 602, UE2 604, and UE3 606) may perform measurement on the sensing RS at 643, 645, and 647. In some aspects, 1010 may be performed by the multi-device aggregation component 198.

In some aspects, to manage the inclusion of the first UE in the aggregation of the multiple UEs (at 1010), the first UE may indicate, in response to the measurement result being lower than a link quality threshold, a failure report indicating an invalidity of the inclusion of the first UE in the aggregation of the multiple UEs. For example, referring to FIG. 8, the first UE 802 may transmit, at 826, in response to the measurement result being lower than a link quality threshold, a failure report to the base station 804. Referring to FIG. 6, if the measurement result (e.g., at 647) indicates a failed association between the UE (e.g., UE2 604) and the object, the UE (e.g., UE2 604) may transmit a failure report 650 to the network 608.

In some aspects, the first UE may, at 1008, receive a fallback configuration from the network entity. To manage the inclusion of the first UE in the aggregation of the multiple UEs (at 1010), the first UE may perform a fallback operation based on the fallback configuration in response to the measurement result being lower than the link quality threshold. The fallback operation may not involve the aggregation of the multiple UEs. For example, referring to FIG. 8, the first UE 802 may, at 814, receive a fallback configuration from the network entity (base station 804). In some aspects, 1008 may be performed by the multi-device aggregation component 198.

In some aspects, the link quality threshold may be the RSRP at the first UE or a relative RSRP back off at the first UE. For example, referring to FIG. 8, the link quality threshold (at 820) may be the RSRP at the first UE 802 or a relative RSRP back off at the first UE 802.

In some aspects, the failure report may further include one or more of: a first request to trigger a fallback beam management (BM), or a second request to reconstruct the aggregation of the multiple UEs. For example, referring to FIG. 8, the failure report (at 826) may further include one or more of: a first request to trigger a fallback beam management (BM), or a second request to reconstruct the aggregation of the multiple UEs.

In some aspects, the MDA indication (at 1006) may further indicate the first UE as a primary UE of the aggregation of the multiple UEs, and, at 1016, the first UE may transmit first CSI for the channel between the first UE and the network entity to the network entity. For example, referring to FIG. 8, the MDA indication (at 812) may further indicate the first UE 802 as a primary UE of the aggregation of the multiple UEs. Referring to FIG. 6, the MDA indication 632 may further indicate UE1 602 as a primary UE of the aggregation of the multiple UEs. In some aspects, 1016 may be performed by the multi-device aggregation component 198.

In some aspects, the first UE may, at 1018, receive, from the network entity, a first CSI configuration including a first report offset and a first report periodicity for reporting first CSI, and, at 1020, transmit, to the network entity, the first CSI for the channel between the first UE and the network entity based on the first report offset and the first report periodicity. For example, referring to FIG. 8, the first UE 802 may, at 836, receive from the network entity (base station 804) a first CSI configuration including a first report offset and a first report periodicity for reporting first CSI, and, at 838, transmit, to the network entity (base station 804), the first CSI for the channel between the first UE and the network entity based on the first report offset and the first report periodicity. In some aspects, 1018 and 1020 may be performed by the multi-device aggregation component 198.

In some aspects, the first UE may, at 1022, receive a positioning configuration indicating an MDA positioning mode from the network entity. The positioning configuration may include one or more of: sidelink information, the measuring periodicity, positioning request information for a positioning operation, or the positioning accuracy for the positioning operation. To perform the MDA operation (at 1014), the first UE may, at 1024, perform, in response to the positioning configuration, the positioning operation to obtain position information. The position information may be based on a position of the object. For example, referring to FIG. 8, the first UE 802 may, at 844, receive a positioning configuration indicating an MDA positioning mode from the network entity (base station 804). The first UE 802 may, at 852, perform, in response to the positioning configuration, the positioning operation to obtain position information. The position information may be based on a position of the object. In some aspects, 1022 and 1024 may be performed by the multi-device aggregation component 198.

In some aspects, to perform the positioning operation to obtain the position information (at 1024), the first UE may transmit, to the network entity in response to the positioning accuracy lower than an accuracy threshold, a low-accuracy indication indicating an inadequacy to perform the positioning operation. For example, referring to FIG. 8, to perform the positioning operation (at 852), the first UE 802 may transmit, to the network entity in response to the positioning accuracy lower than an accuracy threshold, a low-accuracy indication indicating an inadequacy to perform the positioning operation.

In some aspects, the first UE may, at 1012, receive, from a second UE in the multiple UEs via a sidelink between the first UE and the second UE, a sidelink positioning request. To perform the MDA operation (at 1014), the first UE may perform, in response to the sidelink positioning request, a positioning operation to obtain position information, where the position information is based on a position of the object; and transmit, to the second UE via the sidelink, the position information. For example, referring to FIG. 8, the first UE 802 may, at 850, receive, from a second UE 806 via a sidelink between the first UE 802 and the second UE 806, a sidelink positioning request. The first UE 802 may perform the MDA operation (at 852) in response to the sidelink positioning request (at 850). In some aspects, 1012 may be performed by the multi-device aggregation component 198.

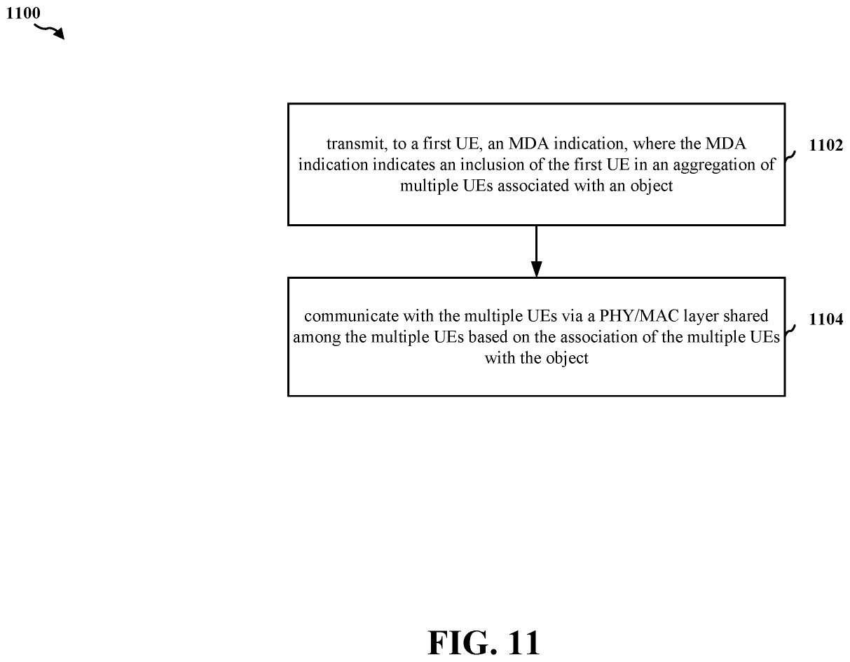

FIG. 11 is a flowchart 1100 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 804; or the network entity 1302 in the hardware implementation of FIG. 13). The methods allow multiple UEs associated with an object to share the PHY/MAC layer data without necessarily sharing higher-layer data. By leveraging the association of multiple devices with the object, the methods optimize the signaling overheads and enhance efficiency in various applications, such as beam managements, CSI reporting, and positioning applications.

As shown in FIG. 11, at 1102, the network entity may transmit, to a first UE, an MDA indication. The MDA indication may indicate the inclusion of the first UE in an aggregation of multiple UEs associated with an object. The first UE may be the UE 104, 350, 802, or the apparatus 1304 in the hardware implementation of FIG. 13. FIG. 6 and FIG. 8 illustrate various aspects of the steps in connection with flowchart 1100. For example, referring to FIG. 8, the network entity (base station 804) may transmit, at 812, to a first UE 802, an MDA indication. The MDA indication may indicate the inclusion of the first UE 802 to an aggregation of multiple UEs associated with an object. Referring to FIG. 6, the network 608 may transmit MDA-based setting indication 632 to UE1 602. In some aspects, 1102 may be performed by the multi-device aggregation component 199.

At 1104, the network entity may communicate with the multiple UEs via a PHY/MAC layer shared among the multiple UEs based on the association of the multiple UEs with the object. For example, referring to FIG. 8, the network entity (base station 804) may communicate, at 832, with the multiple UEs (e.g., the first UE 802) via a PHY/MAC layer shared among the multiple UEs based on the association of the multiple UEs with the object. In some aspects, 1104 may be performed by the multi-device aggregation component 199.

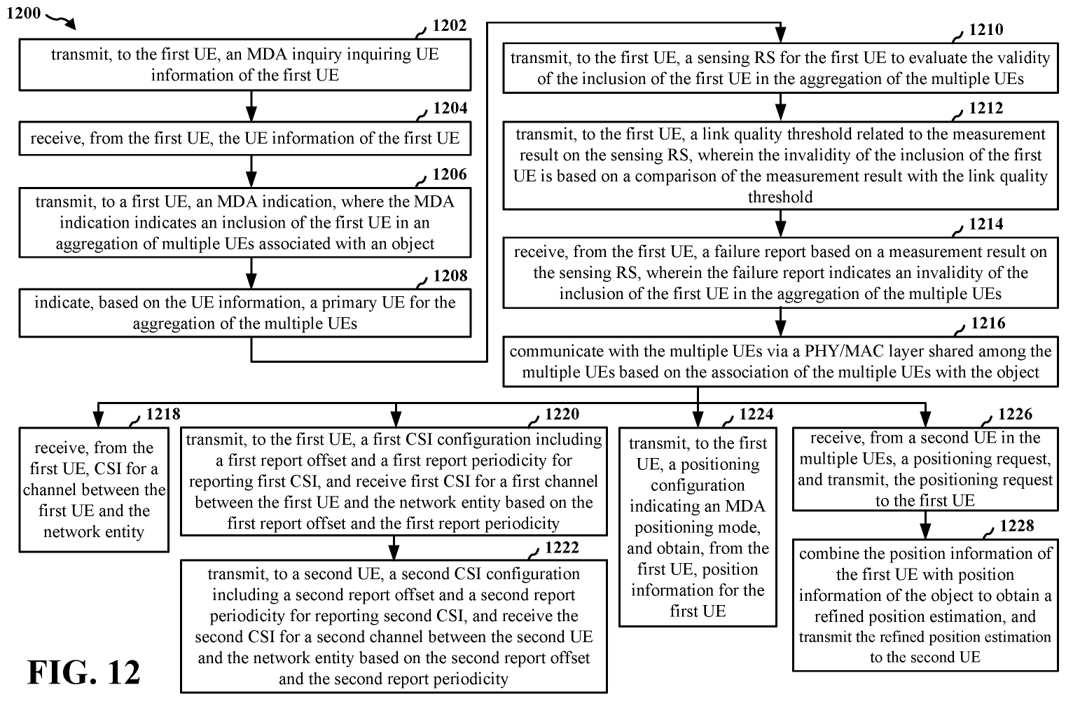

FIG. 12 is a flowchart 1200 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 804; or the network entity 1302 in the hardware implementation of FIG. 13). The methods allow multiple UEs associated with an object to share the PHY/MAC layer data without necessarily sharing higher-layer data. By leveraging the association of multiple devices with the object, the methods optimize the signaling overheads and enhance efficiency in various applications, such as beam managements, CSI reporting, and positioning applications.

As shown in FIG. 12, at 1206, the network entity may transmit, to a first UE, an MDA indication. The MDA indication may indicate the inclusion of the first UE in an aggregation of multiple UEs associated with an object. The first UE may be the UE 104, 350, 802, or the apparatus 1304 in the hardware implementation of FIG. 13. FIG. 6 and FIG. 8 illustrate various aspects of the steps in connection with flowchart 1200. For example, referring to FIG. 8, the network entity (base station 804) may transmit, at 812, to a first UE 802, an MDA indication. The MDA indication may indicate the inclusion of the first UE 802 to an aggregation of multiple UEs associated with an object. Referring to FIG. 6, the network 608 may transmit MDA-based setting indication 632 to UE1 602. In some aspects, 1206 may be performed by the multi-device aggregation component 199.

At 1216, the network entity may communicate with the multiple UEs via a PHY/MAC layer shared among the multiple UEs based on the association of the multiple UEs with the object. For example, referring to FIG. 8, the network entity (base station 804) may communicate, at 832, with the multiple UEs (e.g., the first UE 802) via a PHY/MAC layer shared among the multiple UEs based on the association of the multiple UEs with the object. In some aspects, 1216 may be performed by the multi-device aggregation component 199.

In some aspects, to communicate with the multiple UEs (at 1216), the network entity may perform an MDA operation, and the MDA operation may include one or more of: beam management based on the aggregation of the multiple UEs with the object, CSI report reception based on the aggregation of the multiple UEs with the object, RRM based on the aggregation of the multiple UEs with the object, cell selection or reselection based on the aggregation of the multiple UEs with the object, or a positioning operation based on the aggregation of the multiple UEs with the object. For example, referring to FIG. 8, to communicate with the first UE 802 (at 832), the network entity (base station 804) may, at 830, perform an MDA operation. The MDA operation may include one or more of: beam management based on the aggregation of the multiple UEs with the object, CSI report reception based on the aggregation of the multiple UEs with the object, RRM based on the aggregation of the multiple UEs with the object, cell selection or reselection based on the aggregation of the multiple UEs with the object, or a positioning operation based on the aggregation of the multiple UEs with the object.

In some aspects, the network entity may, at 1202, transmit, to the first UE, an MDA inquiry inquiring UE information of the first UE, and, at 1204, receive, from the first UE, the UE information of the first UE. The UE information of the first UE may include one or more of: the device ID of the first UE, position information of the first UE, the SL capability of the first UE, the battery status of the first UE, or the hardware type of the first UE. For example, referring to FIG. 8, the network entity (base station 804) may, at 808, transmit, to the first UE 802, an MDA inquiry inquiring UE information of the first UE 802, and, at 810, receive, from the first UE 802, the UE information of the first UE 802. The UE information of the first UE 802 may include one or more of: the device ID of the first UE 802, position information of the first UE 802, the SL capability of the first UE 802, the battery status of the first UE 802, or the hardware type of the first UE 802. In some aspects, 1202 and 1204 may be performed by the multi-device aggregation component 199.

In some aspects, the network entity may, at 1208, indicate, based on the UE information, a primary UE for the aggregation of the multiple UEs. For example, referring to FIG. 8, the network entity (base station 804) may, at 816, indicate, based on the UE information, a primary UE for the aggregation of the multiple UEs. In some aspects, 1208 may be performed by the multi-device aggregation component 199.

In some aspects, to indicate the primary UE for the aggregation of the multiple UEs (at 1208), the network entity may indicate the primary UE based on the battery statuses of the multiple UEs. For example, referring to FIG. 8, to indicate the primary UE for the aggregation of the multiple UEs (at 816), the network entity (base station 804) may indicate the primary UE based on the battery statuses of the multiple UEs.

In some aspects, the network entity may, at 1210, transmit to the first UE a sensing RS for the first UE to evaluate the validity of the inclusion of the first UE in the aggregation of the multiple UEs. For example, referring to FIG. 8, the network entity (base station 804) may, at 818, transmit to the first UE 802 a sensing RS for the first UE 802 to evaluate the validity of the inclusion of the first UE 802 to the aggregation of the multiple UEs. Referring to FIG. 6, the network 608 may transmit the sensing RS to the UE (e.g., UE1 602) at 642, 644, and 646. In some aspects, 1210 may be performed by the multi-device aggregation component 199.

In some aspects, the network entity may, at 1214, receive, from the first UE, a failure report based on the measurement result on the sensing RS. The failure report may indicate the invalidity of the inclusion of the first UE in the aggregation of the multiple UEs. For example, referring to FIG. 8, the network entity (base station 804) may, at 826, receive, from the first UE 802, a failure report based on the measurement result on the sensing RS. Referring to FIG. 6, if the measurement result (e.g., at 647) indicates a failed association between the UE (e.g., UE2 604) and the object, the UE (e.g., UE2 604) may transmit a failure report 650 to the network 608. In some aspects, 1214 may be performed by the multi-device aggregation component 199.

In some aspects, the measurement result (at 1214) may be based on the RSRP of the sensing RS at the first UE or the relative RSRP back off of the sensing RS at the first UE. For example, referring to FIG. 8, the measurement result (at 822) may be based on the RSRP of the sensing RS at the first UE 802 or the relative RSRP back off of the sensing RS at the first UE 802.

In some aspects, the network entity may, at 1212, transmit, to the first UE, a link quality threshold related to the measurement result on the sensing RS. The invalidity of the inclusion of the first UE (at 1214) may be based on the comparison of the measurement result with the link quality threshold. For example, referring to FIG. 8, the network entity (base station 804) may, at 820, transmit, to the first UE 802, a link quality threshold related to the measurement result on the sensing RS. In some aspects, 1212 may be performed by the multi-device aggregation component 199.

In some aspects, the MDA indication (at 1206) may further indicate the first UE as a primary UE of the aggregation of the multiple UEs, and the network entity may receive, at 1218, from the first UE, CSI for the channel between the first UE and the network entity. For example, referring to FIG. 8, the network entity (base station 804) may receive, at 834, from the first UE 802, CSI for the channel between the first UE 802 and the network entity (base station 804). In some aspects, 1218 may be performed by the multi-device aggregation component 199.

In some aspects, the network entity may transmit, at 1220, to the first UE, a first CSI configuration including a first report offset and a first report periodicity for reporting first CSI, and receive, from the first UE, first CSI for a first channel between the first UE and the network entity based on the first report offset and the first report periodicity. For example, referring to FIG. 8, the network entity (base station 804) may transmit, at 836, to the first UE 802, a first CSI configuration including a first report offset and a first report periodicity for reporting first CSI, and receive, at 838 from the first UE 802, first CSI for a first channel between the first UE 802 and the network entity (base station 804) based on the first report offset and the first report periodicity. In some aspects, 1220 may be performed by the multi-device aggregation component 199.

In some aspects, the network entity may, at 1222, transmit, to a second UE in the multiple UEs, a second CSI configuration including a second report offset and a second report periodicity for reporting second CSI, and receive, from the second UE, the second CSI for a second channel between the second UE and the network entity based on the second report offset and the second report periodicity. For example, referring to FIG. 8, the network entity (base station 804) may, at 840, transmit, to a second UE 806, a second CSI configuration including a second report offset and a second report periodicity for reporting second CSI, and receive, at 842 from the second UE 806, the second CSI for a second channel between the second UE and the network entity based on the second report offset and the second report periodicity. In some aspects, 1222 may be performed by the multi-device aggregation component 199.

In some aspects, the network entity may, at 1224, transmit, to the first UE, a positioning configuration indicating an MDA positioning mode, and obtain, from the first UE, position information for the first UE. The positioning configuration may include one or more of: sidelink information, the measuring periodicity, the positioning request information for the positioning operation, or the positioning accuracy for the positioning operation. The position information may be based on position information of the object. For example, referring to FIG. 8, the network entity (base station 804) may, at 844, transmit, to the first UE 802, a positioning configuration indicating an MDA positioning mode, and obtain, at 848 from the first UE 802, position information for the first UE 802. In some aspects, 1224 may be performed by the multi-device aggregation component 199.

In some aspects, the network entity may, at 1226, receive, from a second UE in the multiple UEs, a positioning request, and transmit, the positioning request to the first UE to indicate the first UE to perform a positioning operation to obtain position information of the first UE. For example, referring to FIG. 8, the network entity (base station 804) may, at 846, receive, from a second UE 806, a positioning request, and transmit, at 848, the positioning request to the first UE 802 to indicate the first UE 802 to perform, at 850, a positioning operation to obtain position information of the first UE 802. In some aspects, 1226 may be performed by the multi-device aggregation component 199.

In some aspects, the network entity may, at 1228, combine the position information of the first UE with position information of the object to obtain a refined position estimation, and transmit the refined position estimation to the second UE. For example, referring to FIG. 8, the network entity (base station 804) may, at 854, combine the position information of the first UE 802 with position information of the object to obtain a refined position estimation, and transmit, at 856, the refined position estimation to the second UE 806. In some aspects, 1228 may be performed by the multi-device aggregation component 199.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor 1324 (also referred to as a modem) coupled to one or more transceivers 1322 (e.g., cellular RF transceiver). The cellular baseband processor(s) 1324 may include at least one on-chip memory 1324′. In some aspects, the apparatus 1304 may further include one or more subscriber identity modules (SIM) cards 1320 and at least one application processor 1306 coupled to a secure digital (SD) card 1308 and a screen 1310. The application processor(s) 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) 1324 communicates through the transceiver(s) 1322 via one or more antennas 1380 with the UE 104 and/or with an RU associated with a network entity 1302. The cellular baseband processor(s) 1324 and the application processor(s) 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor(s) 1324 and the application processor(s) 1306 are each responsible for general processing, including the execution of software stored on the computer-readable medium/memory. The software, when executed by the cellular baseband processor(s) 1324/application processor(s) 1306, causes the cellular baseband processor(s) 1324/application processor(s) 1306 to perform the various functions described supra. The cellular baseband processor(s) 1324 and the application processor(s) 1306 are configured to perform the various functions described supra based at least in part of the information stored in the memory. That is, the cellular baseband processor(s) 1324 and the application processor(s) 1306 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1324/application processor(s) 1306 when executing software. The cellular baseband processor(s) 1324/application processor(s) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) 1324 and/or the application processor(s) 1306, and in another configuration, the apparatus 1304 may be the entire UE (e.g., see UE 350 of FIG. 3) and include the additional modules of the apparatus 1304.

As discussed supra, the component 198 may be configured to receive, from a network entity, an MDA indication. The MDA indication may indicate an inclusion of the first UE in an aggregation of multiple UEs associated with an object. The component 198 may be further configured to perform, based on the aggregation of the multiple UEs, an MDA operation via a PHY/MAC layer shared among the multiple UEs. The component 198 may be further configured to perform any of the aspects described in connection with the flowcharts in FIG. 9 and FIG. 10, and/or performed by the UE 802 in FIG. 8. The component 198 may be within the cellular baseband processor(s) 1324, the application processor(s) 1306, or both the cellular baseband processor(s) 1324 and the application processor(s) 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) 1324 and/or the application processor(s) 1306, includes means for receiving, from a network entity, an MDA indication, where the MDA indication indicates an inclusion of the first UE in an aggregation of multiple UEs associated with an object, and means for performing, based on the aggregation of the multiple UEs, an MDA operation via a PHY/MAC layer shared among the multiple UEs. The apparatus 1304 may further include means for performing any of the aspects described in connection with the flowcharts in FIG. 9 and FIG. 10, and/or aspects performed by the UE 802 in FIG. 8. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

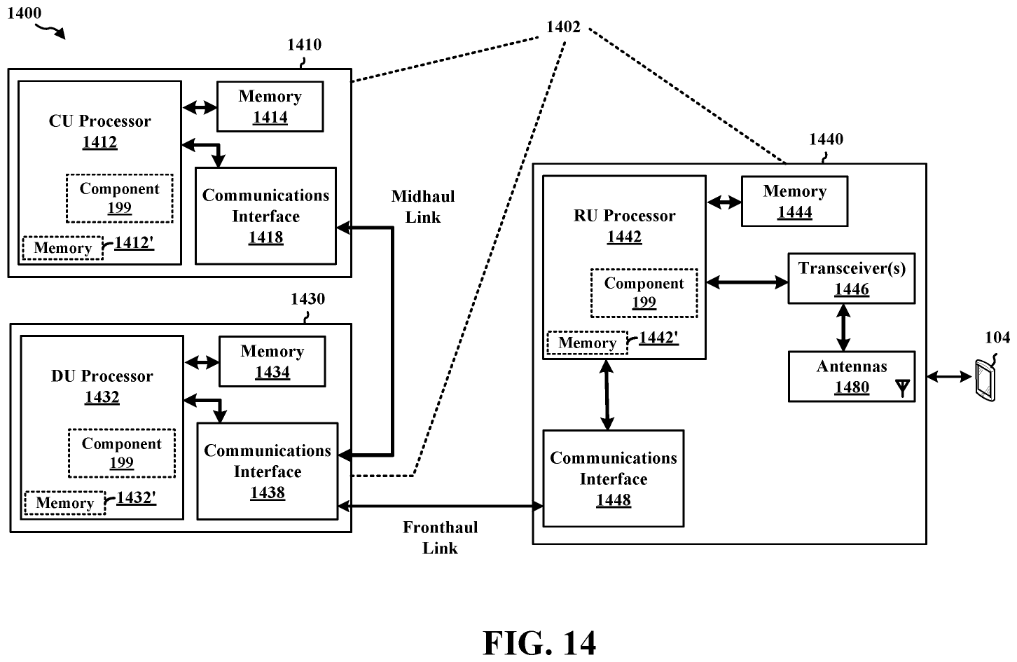

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor 1412. The CU processor(s) 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor 1432. The DU processor(s) 1432 may include on-chip memory 1432′. In some aspects, the DU 1430 may further include additional memory modules 1434 and a communications interface 1438. The DU 1430 communicates with the RU 1440 through a fronthaul link. The RU 1440 may include at least one RU processor 1442. The RU processor(s) 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, to a first UE, an MDA indication. The MDA indication may indicate an inclusion of the first UE in an aggregation of multiple UEs associated with an object. The component 199 may be further configured to communicate with the multiple UEs via a PHY/MAC layer shared among the multiple UEs based on the association of the multiple UEs with the object. The component 199 may be further configured to perform any of the aspects described in connection with the flowcharts in FIG. 11 and FIG. 12, and/or performed by the base station 804 in FIG. 8. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 includes means for transmitting, to a first UE, an MDA indication, where the MDA indication indicates an inclusion of the first UE in an aggregation of multiple UEs associated with an object, and means for communicating with the multiple UEs via a PHY/MAC layer shared among the multiple UEs based on the association of the multiple UEs with the object. The network entity 1402 may further include means for performing any of the aspects described in connection with the flowcharts in FIG. 11 and FIG. 12, and/or aspects performed by the base station 804 in FIG. 8. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, an MDA indication, where the MDA indication indicates an inclusion of the first UE in an aggregation of multiple UEs associated with an object; and performing, based on the aggregation of the multiple UEs, an MDA operation via a PHY/MAC layer shared among the multiple UEs. The methods allow multiple UEs associated with an object to share the PHY/MAC layer data without necessarily sharing higher-layer data. By leveraging the association of multiple devices with the object, the methods optimize the signaling overheads and enhance efficiency in various applications, such as beam managements, CSI reporting, and positioning applications.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first UE. The method may include receiving, from a network entity, a multi-device aggregation (MDA) indication, wherein the MDA indication indicates an inclusion of the first UE in an aggregation of multiple UEs associated with an object; and performing, based on the aggregation of the multiple UEs, an MDA operation via a physical (PHY) or medium access control (MAC) layer shared among the multiple UEs.

Aspect 2 is the method of aspect 1, wherein the MDA operation may include one or more of: beam management based on the aggregation of the multiple UEs with the object, channel state information (CSI) measurement or reporting based on the aggregation of the multiple UEs with the object, radio resource management (RRM) based on the aggregation of the multiple UEs with the object, cell selection or reselection based on the aggregation of the multiple UEs with the object, or a positioning operation based on the aggregation of the multiple UEs with the object.

Aspect 3 is the method of any of aspects 1 to 2, where the method may further include receiving, from the network entity, an MDA inquiry inquiring UE information of the first UE; and transmitting, to the network entity in response to the MDA inquiry, the UE information of the first UE. The UE information of the first UE may include one or more of: a device identifier (ID) of the first UE, position information of the first UE, a sidelink (SL) capability of the first UE, a battery status of the first UE, or a hardware type of the first UE.

Aspect 4 is the method of any of aspects 1 to 3, where the method may further include measuring a sensing reference signal (RS) to obtain a measurement result; and managing, based on the measurement result, the inclusion of the first UE in the aggregation of the multiple UEs.

Aspect 5 is the method of aspect 4, wherein managing the inclusion of the first UE in the aggregation of the multiple UEs may include indicating, in response to the measurement result being lower than a link quality threshold, a failure report indicating an invalidity of the inclusion of the first UE in the aggregation of the multiple UEs.

Aspect 6 is the method of aspect 5, where the method may further include receiving, from the network entity, a fallback configuration, and managing the inclusion of the first UE in the aggregation of the multiple UEs may include performing, based on the fallback configuration in response to the measurement result being lower than the link quality threshold, a fallback operation not involving the aggregation of the multiple UEs.

Aspect 7 is the method of aspect 5, wherein the link quality threshold may be a reference signal received power (RSRP) at the first UE or a relative RSRP back off at the first UE.

Aspect 8 is the method of aspect 5, wherein the failure report may further include one or more of: a first request to trigger a fallback beam management (BM), or a second request to reconstruct the aggregation of the multiple UEs.

Aspect 9 is the method of any of aspects 1 to 8, wherein the MDA indication may further indicate the first UE as a primary UE of the aggregation of the multiple UEs, and the method may further include transmitting, to the network entity, first channel state information (CSI) for a channel between the first UE and the network entity.

Aspect 10 is the method of any of aspects 1 to 8, where the method may further include receiving, from the network entity, a first channel state information (CSI) configuration comprising a first report offset and a first report periodicity for reporting CSI; and transmitting, to the network entity, first CSI for a channel between the first UE and the network entity based on the first report offset and the first report periodicity.

Aspect 11 is the method of any of aspects 1 to 10, where the method may further include receiving, from the network entity, a positioning configuration indicating an MDA positioning mode, wherein the positioning configuration includes one or more of: sidelink information, a measuring periodicity, positioning request information for a positioning operation, or a positioning accuracy for the positioning operation, and wherein performing the MDA operation may include performing, in response to the positioning configuration, the positioning operation to obtain position information, wherein the position information is based on a position of the object.

Aspect 12 is the method of aspect 11, wherein performing the positioning operation to obtain the position information may include transmitting, to the network entity in response to the positioning accuracy lower than an accuracy threshold, a low-accuracy indication indicating an inadequacy to perform the positioning operation.

Aspect 13 is the method of any of aspects 1 to 12, where the method may further include receiving, from a second UE in the multiple UEs via a sidelink between the first UE and the second UE, a sidelink positioning request, and performing the MDA operation may include performing, in response to the sidelink positioning request, a positioning operation to obtain position information, wherein the position information is based on a position of the object; and transmitting, to the second UE via the sidelink, the position information.

Aspect 14 is an apparatus for wireless communication at a first UE, comprising: a processing system that includes processor circuitry and memory circuitry that stores code and is coupled with the processor circuitry, the processing system configured to cause the UE to perform the method of one or more of Aspects 1-13.

Aspect 15 is an apparatus for wireless communication at a first UE, comprising: at least one memory; and at least one processor coupled to the at least one memory and, based at least in part on information stored in the at least one memory, the at least one processor, individually or in any combination, is configured to perform the method of any of aspects 1-13.

Aspect 16 is the apparatus for wireless communication at a first UE, comprising means for performing each step in the method of any of aspects 1-13.

Aspect 17 is an apparatus of any of aspects 14-16, further comprising a transceiver configured to receive or to transmit in association with the method of any of aspects 1-13.

Aspect 18 is a computer-readable medium (e.g., a non-transitory computer-readable medium) storing computer executable code at a first UE, the code when executed by at least one processor causes the at least one processor to, individually or in any combination, perform the method of any of aspects 1-13.

Aspect 19 is a method of wireless communication at a network entity. The method may include transmitting, to a first user equipment (UE), a multi-device aggregation (MDA) indication, wherein the MDA indication indicates an inclusion of the first UE in an aggregation of multiple UEs associated with an object; and communicating with the multiple UEs via a physical (PHY) or medium access control (MAC) layer shared among the multiple UEs based on the association of the multiple UEs with the object.

Aspect 20 is the method of aspect 19, where communicating with the multiple UEs may include performing an MDA operation that includes at least one of: beam management based on the aggregation of the multiple UEs with the object, channel state information (CSI) report reception based on the aggregation of the multiple UEs with the object, radio resource management (RRM) based on the aggregation of the multiple UEs with the object, cell selection or reselection based on the aggregation of the multiple UEs with the object, or a positioning operation based on the aggregation of the multiple UEs with the object.

Aspect 21 is the method of any of aspects 19 to 20, where the method may further include transmitting, to the first UE, an MDA inquiry inquiring UE information of the first UE; and receiving, from the first UE, the UE information of the first UE, wherein the UE information of the first UE may include one or more of: a device identifier (ID) of the first UE, position information of the first UE, a sidelink (SL) capability of the first UE, a battery status of the first UE, or a hardware type of the first UE.

Aspect 22 is the method of aspect 21, where the method may further include indicating, based on the UE information, a primary UE for the aggregation of the multiple UEs.

Aspect 23 is the method of aspect 22, wherein indicating the primary UE for the aggregation of the multiple UEs may include indicating, based on the battery statuses of the multiple UEs, the primary UE.

Aspect 24 is the method of any of aspects 19 to 23, where the method may further include transmitting, to the first UE, a sensing reference signal (RS) for the first UE to evaluate a validity of the inclusion of the first UE in the aggregation of the multiple UEs.

Aspect 25 is the method of aspect 24, where the method may further include receiving, from the first UE, a failure report based on a measurement result on the sensing RS, wherein the failure report indicates an invalidity of the inclusion of the first UE in the aggregation of the multiple UEs.

Aspect 26 is the method of aspect 25, wherein the measurement result may be based on a reference signal received power (RSRP) of the sensing RS at the first UE or a relative RSRP back off of the sensing RS at the first UE.

Aspect 27 is the method of any of aspects 25 to 26, where the method may further include transmitting, to the first UE, a link quality threshold related to the measurement result on the sensing RS, wherein the invalidity of the inclusion of the first UE may be based on a comparison of the measurement result with the link quality threshold.

Aspect 28 is the method of any of aspects 19 to 27, wherein the MDA indication may further indicate the first UE as a primary UE of the aggregation of the multiple UEs, and the method may further include receiving, from the first UE, channel state information (CSI) for a channel between the first UE and the network entity.

Aspect 29 is the method of any of aspects 19 to 28, where the method may further include transmitting, to the first UE, a first channel state information (CSI) configuration comprising a first report offset and a first report periodicity for reporting first CSI; and receiving, from the first UE, first CSI for a first channel between the first UE and the network entity based on the first report offset and the first report periodicity.

Aspect 30 is the method of aspect 29, where the method may further include transmitting, to a second UE in the multiple UEs, a second CSI configuration comprising a second report offset and a second report periodicity for reporting second CSI; and receiving, from the second UE, the second CSI for a second channel between the second UE and the network entity based on the second report offset and the second report periodicity.

Aspect 31 is the method of any of aspects 19 to 30, wherein the method may further include transmitting, to the first UE, a positioning configuration indicating an MDA positioning mode, wherein the positioning configuration includes one or more of: sidelink information, a measuring periodicity, positioning request information for a positioning operation, or a positioning accuracy for the positioning operation; and obtaining, from the first UE, position information for the first UE, wherein the position information is based on position information of the object.

Aspect 32 is the method of any of aspects 19 to 31, wherein the method may further include receiving, from a second UE in the multiple UEs, a positioning request, and transmitting, the positioning request to the first UE to indicate the first UE to perform a positioning operation to obtain position information of the first UE.

Aspect 33 is the method of aspect 32, where the method may further include combining the position information of the first UE with object position information of the object to obtain a refined position estimation; and transmitting the refined position estimation to the second UE.

Aspect 34 is an apparatus for wireless communication at a network entity, comprising: a processing system that includes processor circuitry and memory circuitry that stores code and is coupled with the processor circuitry, the processing system configured to cause the network entity to perform the method of one or more of Aspects 19-33.

Aspect 35 is an apparatus for wireless communication at a network entity, comprising: at least one memory; and at least one processor coupled to the at least one memory and, based at least in part on information stored in the at least one memory, the at least one processor, individually or in any combination, is configured to perform the method of any of aspects 19-33.

Aspect 36 is the apparatus for wireless communication at a network entity, comprising means for performing each step in the method of any of aspects 19-33.

Aspect 37 is an apparatus of any of aspects 34-36, further comprising a transceiver configured to receive or to transmit in association with the method of any of aspects 19-33.

Aspect 38 is a computer-readable medium (e.g., a non-transitory computer-readable medium) storing computer executable code at a network entity, the code when executed by at least one processor causes the at least one processor to, individually or in any combination, perform the method of any of aspects 19-33.

What is claimed is:

1. An apparatus for wireless communication at a first user equipment (UE), comprising:
at least one memory; and
at least one processor coupled to the at least one memory and, based at least in part on information stored in the at least one memory, the at least one processor, individually or in any combination, is configured to cause the first UE to:
receive a multi-device aggregation (MDA) indication from a network entity, wherein the MDA indication indicates an inclusion of the first UE in an aggregation of multiple UEs associated with an object; and
perform, based on the aggregation of the multiple UEs, an MDA operation via a physical (PHY) or medium access control (MAC) layer shared among the multiple UEs.

2. The apparatus of claim 1, further comprising a transceiver coupled to the at least one processor, wherein, to receive the MDA indication, the at least one processor, individually or in any combination, is configured to cause the first UE to receive the MDA indication via the transceiver, and wherein the MDA operation includes one or more of:
beam management based on the aggregation of the multiple UEs with the object,
channel state information (CSI) measurement or reporting based on the aggregation of the multiple UEs with the object,
radio resource management (RRM) based on the aggregation of the multiple UEs with the object,
cell selection or reselection based on the aggregation of the multiple UEs with the object, or
a positioning operation based on the aggregation of the multiple UEs with the object.

3. The apparatus of claim 1, wherein the at least one processor, individually or in any combination, is further configured to cause the first UE to:
receive, from the network entity, an MDA inquiry inquiring UE information of the first UE; and
transmit, to the network entity in response to the MDA inquiry, the UE information of the first UE, wherein the UE information of the first UE includes one or more of:
a device identifier (ID) of the first UE,
position information of the first UE,
a sidelink (SL) capability of the first UE,
a battery status of the first UE, or
a hardware type of the first UE.

4. The apparatus of claim 1, wherein the at least one processor, individually or in any combination, is further configured to cause the first UE to:
measure a sensing reference signal (RS) to obtain a measurement result; and
manage, based on the measurement result, the inclusion of the first UE in the aggregation of the multiple UEs.

5. The apparatus of claim 4, wherein, to manage the inclusion of the first UE in the aggregation of the multiple UEs, the at least one processor, individually or in any combination, is configured to cause the first UE to:
indicate, in response to the measurement result being lower than a link quality threshold, a failure report indicating an invalidity of the inclusion of the first UE in the aggregation of the multiple UEs.

6. The apparatus of claim 5, wherein the at least one processor, individually or in any combination, is further configured to cause the first UE to:
receive, from the network entity, a fallback configuration, and wherein to manage the inclusion of the first UE in the aggregation of the multiple UEs, the at least one processor, individually or in any combination, is configured to cause the first UE to:
perform, based on the fallback configuration in response to the measurement result being lower than the link quality threshold, a fallback operation not involving the aggregation of the multiple UEs.

7. The apparatus of claim 5, wherein the link quality threshold is a reference signal received power (RSRP) at the first UE or a relative RSRP back off at the first UE.

8. The apparatus of claim 5, wherein the failure report further includes one or more of:
a first request to trigger a fallback beam management (BM), or
a second request to reconstruct the aggregation of the multiple UEs.

9. The apparatus of claim 1, wherein the MDA indication further indicates the first UE as a primary UE of the aggregation of the multiple UEs, and wherein the at least one processor, individually or in any combination, is further configured to cause the first UE to:
transmit, to the network entity, first channel state information (CSI) for a channel between the first UE and the network entity.

10. The apparatus of claim 1, wherein the at least one processor, individually or in any combination, is further configured to cause the first UE to:
receive, from the network entity, a first channel state information (CSI) configuration comprising a first report offset and a first report periodicity for reporting first CSI; and
transmit, to the network entity, the first CSI for a channel between the first UE and the network entity based on the first report offset and the first report periodicity.

11. The apparatus of claim 1, wherein the at least one processor, individually or in any combination, is further configured to cause the first UE to:
receive, from the network entity, a positioning configuration indicating an MDA positioning mode, wherein the positioning configuration includes one or more of:
sidelink information,
a measuring periodicity,
positioning request information for a positioning operation, or
a positioning accuracy for the positioning operation, and wherein to perform the MDA operation, the at least one processor, individually or in any combination, is configured to cause the first UE to:
perform, in response to the positioning configuration, the positioning operation to obtain position information, wherein the position information is based on a position of the object.

12. The apparatus of claim 11, wherein to perform the positioning operation to obtain the position information, the at least one processor, individually or in any combination, is further configured to cause the first UE to:
transmit, to the network entity in response to the positioning accuracy lower than an accuracy threshold, a low-accuracy indication indicating an inadequacy to perform the positioning operation.

13. The apparatus of claim 1, wherein the at least one processor, individually or in any combination, is further configured to cause the first UE to:
receive, from a second UE in the multiple UEs via a sidelink between the first UE and the second UE, a sidelink positioning request, and wherein to perform the MDA operation, the at least one processor, individually or in any combination, is configured to cause the first UE to:
perform, in response to the sidelink positioning request, a positioning operation to obtain position information, wherein the position information is based on a position of the object; and
transmit, to the second UE via the sidelink, the position information.

14. An apparatus for wireless communication at a network entity, comprising:
at least one memory; and
at least one processor coupled to the at least one memory and, based at least in part on information stored in the at least one memory, the at least one processor, individually or in any combination, is configured to cause the network entity to:
transmit, to a first user equipment (UE), a multi-device aggregation (MDA) indication, wherein the MDA indication indicates an inclusion of the first UE in an aggregation of multiple UEs associated with an object; and
communicate with the multiple UEs via a physical (PHY) or medium access control (MAC) layer shared among the multiple UEs based on the association of the multiple UEs with the object.

15. The apparatus of claim 14, further comprising a transceiver coupled to the at least one processor, wherein, to transmit the MDA indication, the at least one processor, individually or in any combination, is configured to cause the network entity to transmit the MDA indication via the transceiver, and wherein to communicate with the multiple UEs, the at least one processor, individually or in any combination, is configured to cause the network entity to perform an MDA operation that includes at least one of:
beam management based on the aggregation of the multiple UEs with the object,
channel state information (CSI) report reception based on the aggregation of the multiple UEs with the object,
radio resource management (RRM) based on the aggregation of the multiple UEs with the object,
cell selection or reselection based on the aggregation of the multiple UEs with the object, or
a positioning operation based on the aggregation of the multiple UEs with the object.

16. The apparatus of claim 14, wherein the at least one processor, individually or in any combination, is further configured to cause the network entity to:
transmit, to the first UE, an MDA inquiry inquiring UE information of the first UE; and
receive, from the first UE, the UE information of the first UE, wherein the UE information of the first UE includes one or more of:
a device identifier (ID) of the first UE,
position information of the first UE,
a sidelink (SL) capability of the first UE,
a battery status of the first UE, or
a hardware type of the first UE.

17. The apparatus of claim 16, wherein the at least one processor, individually or in any combination, is further configured to cause the network entity to:
indicate, based on the UE information, a primary UE for the aggregation of the multiple UEs.

18. The apparatus of claim 17, wherein to indicate the primary UE for the aggregation of the multiple UEs, the at least one processor, individually or in any combination, is configured to cause the network entity to:
indicate, based on the battery statuses of the multiple UEs, the primary UE.

19. The apparatus of claim 17, wherein the at least one processor, individually or in any combination, is further configured to cause the network entity to:
transmit, to the first UE, a sensing reference signal (RS) for the first UE to evaluate a validity of the inclusion of the first UE in the aggregation of the multiple UEs.

20. The apparatus of claim 19, wherein the at least one processor, individually or in any combination, is further configured to cause the network entity to:
receive, from the first UE, a failure report based on a measurement result on the sensing RS, wherein the failure report indicates an invalidity of the inclusion of the first UE in the aggregation of the multiple UEs.

21. The apparatus of claim 20, wherein the measurement result is based on a reference signal received power (RSRP) of the sensing RS at the first UE or a relative RSRP back off of the sensing RS at the first UE.

22. The apparatus of claim 20, wherein the at least one processor, individually or in any combination, is further configured to cause the network entity to:
transmit, to the first UE, a link quality threshold related to the measurement result on the sensing RS, wherein the invalidity of the inclusion of the first UE is based on a comparison of the measurement result with the link quality threshold.

23. The apparatus of claim 14, wherein the MDA indication further indicates the first UE as a primary UE of the aggregation of the multiple UEs, and wherein the at least one processor, individually or in any combination, is further configured to cause the network entity to:
receive, from the first UE, channel state information (CSI) for a channel between the first UE and the network entity.

24. The apparatus of claim 14, wherein the at least one processor, individually or in any combination, is further configured to cause the network entity to:
transmit, to the first UE, a first channel state information (CSI) configuration comprising a first report offset and a first report periodicity for reporting first CSI; and
receive, from the first UE, first CSI for a first channel between the first UE and the network entity based on the first report offset and the first report periodicity.

25. The apparatus of claim 24, wherein the at least one processor, individually or in any combination, is further configured to cause the network entity to:
transmit, to a second UE in the multiple UEs, a second CSI configuration comprising a second report offset and a second report periodicity for reporting second CSI; and
receive, from the second UE, the second CSI for a second channel between the second UE and the network entity based on the second report offset and the second report periodicity.

26. The apparatus of claim 14, wherein the at least one processor, individually or in any combination, is further configured to cause the network entity to:
transmit, to the first UE, a positioning configuration indicating an MDA positioning mode, wherein the positioning configuration includes one or more of:
sidelink information,
a measuring periodicity,
positioning request information for a positioning operation, or
a positioning accuracy for the positioning operation; and
obtain, from the first UE, object position information for the first UE, wherein the object position information is based on position information of the object.

27. The apparatus of claim 14, wherein the at least one processor, individually or in any combination, is further configured to cause the network entity to:
receive, from a second UE in the multiple UEs, a positioning request, and
transmit, the positioning request to the first UE to indicate the first UE to perform a positioning operation to obtain position information of the first UE.

28. The apparatus of claim 27, wherein the at least one processor, individually or in any combination, is further configured to cause the network entity to:
combine the position information of the first UE with the position information of the object to obtain a refined position estimation; and
transmit the refined position estimation to the second UE.

29. A method for wireless communication at a first user equipment (UE), comprising:
receiving, from a network entity, a multi-device aggregation (MDA) indication, wherein the MDA indication indicates an inclusion of the first UE in an aggregation of multiple UEs associated with an object; and
performing, based on the aggregation of the multiple UEs, an MDA operation via a physical (PHY) or medium access control (MAC) layer shared among the multiple UEs.

30. A method for wireless communication at a network entity, comprising:
transmitting, to a first user equipment (UE), a multi-device aggregation (MDA) indication, wherein the MDA indication indicates an inclusion of the first UE in an aggregation of multiple UEs associated with an object; and
communicating with the multiple UEs via a physical (PHY) or medium access control (MAC) layer shared among the multiple UEs based on the association of the multiple UEs with the object.
